(19) United States
(12) Patent Application Publication
(10) Pub. No.: US 2026/0259711 A1
(43) Pub. Date: Sep. 3, 2026

(54) REDUNDANCY ELIMINATION TECHNIQUES

(71) Applicant: QUALCOMM Incorporated, San Diego, CA (US)

(72) Inventor: Jeeva PAUDEL, San Jose, CA (US)

(21) Appl. No.: 19/067,713

(22) Filed: Feb. 28, 2025

(51) Int. Cl. G06F 8/41

(52) U.S. Cl. CPC G06F 8/41

(57) ABSTRACT

This disclosure provides systems, devices, apparatus, and methods, including computer programs encoded on storage media, for optimizing a control flow graph of a representation of source code. A processor may obtain a control flow graph including a set of instruction blocks. The processor may identify a set of inefficient instruction blocks that include a set of redundant instructions. The processor may determine a set of complex inefficient instruction blocks that include non-isomorphic regions that are eligible for a transformation. The processor may perform code motion on a complex control flow region of the control flow graph based on the determined set of complex inefficient instruction blocks. The processor may simplify a control flow of the complex control flow region based on the performed code motion. The processor may fuse a first redundancy portion and a second redundancy portion of the set of redundant instructions based on the simplified control flow.

### TECHNICAL FIELD

The present disclosure relates generally to processing systems, and more particularly, to one or more techniques for optimizing complex control flows aimed at redundancy elimination.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current source code optimization techniques may not address complex control flows with non-isomorphic redundancies. There is a need for improved control flow redundancy elimination techniques.

### BRIEF SUMMARY

In an aspect of the disclosure, a method, a computer-readable medium, and an apparatus are provided. The apparatus may include a memory; and at least one processor coupled to the memory and, based at least in part on information stored in the memory, the at least one processor may be configured to obtain a control flow graph. The control flow graph may include a set of instruction blocks. The processor(s) may identify a set of inefficient instruction blocks that include a set of redundant instructions based on the obtained control flow graph. The processor(s) may determine a set of complex inefficient instruction blocks that include non-isomorphic regions that are eligible for a transformation based on the identified set of complex inefficient instruction blocks. The processor(s) may perform code motion on a complex control flow region of the control flow graph based on the determined set of complex inefficient instruction blocks. The processor(s) may simplify a control flow of the complex control flow region based on the performed code motion. The processor(s) may fuse a first redundancy portion and a second redundancy portion of the control flow graph based on the simplified control flow.

In some aspects, the techniques described herein relate to a method of optimizing a control flow graph, including: obtaining the control flow graph, where the control flow graph includes a set of instruction blocks; identifying a set of inefficient instruction blocks including a set of redundant instructions based on the obtained control flow graph; determining a set of complex inefficient instruction blocks including non-isomorphic regions that are eligible for a transformation based on the identified set of complex inefficient instruction blocks; performing code motion of a complex control flow region of the control flow graph based on the determined set of complex inefficient instruction blocks; simplifying a control flow of the complex control flow region based on the performed code motion; and fusing a first redundancy portion and a second redundancy portion of the set of redundant instructions based on the simplified control flow.

In some aspects, the techniques described herein relate to a method, further including: compiling a representation of source code based on the control flow graph including the fused first redundancy portion and the second redundancy portion; and outputting the compiled representation of source code.

In some aspects, the techniques described herein relate to a method, where performing code motion of the complex control flow region of the control flow graph based on the determined set of complex inefficient instruction blocks includes at least one of: hoisting code outside the complex control flow region; sinking code into the complex control flow region; or factoring code in the complex control flow region.

In some aspects, the techniques described herein relate to a method, where performing code motion of the complex control flow region of the control flow graph based on the determined set of complex inefficient instruction blocks includes at least one of: moving a region of the complex control flow region based on divergent branches of the complex control flow region; moving the region of the complex control flow region based on early termination constructs of the complex control flow region; moving the region of the complex control flow region based on a register footprint of the complex control flow region; moving the region of the complex control flow region based on an instruction count of the complex control flow region; moving the region of the complex control flow region based on a locality sensitivity of the complex control flow region; moving the region of the complex control flow region based on a latency sensitivity of the complex control flow region; or moving the region of the complex control flow region based on an elementary functional unit (EFU) grouping of the complex control flow region.

In some aspects, the techniques described herein relate to a method, where simplifying the control flow of the transformed complex control flow region includes: reducing a plurality of exit outputs of the control flow of the transformed complex control flow region to a single exit output.

In some aspects, the techniques described herein relate to a method, where fusing the first redundancy portion and the second redundancy portion of the set of redundant instructions based on the simplified control flow includes: fusing the first redundancy portion and the second redundancy portion of the set of redundant instructions based on the simplified control flow based on a determination that the first redundancy portion and the second redundancy portion reached a steady state.

In some aspects, the techniques described herein relate to a method, further including: transforming the complex control flow region based on the performed code motion before simplifying the control flow of the complex control flow region.

In some aspects, the techniques described herein relate to a method, where transforming the complex control flow region based on the performed code motion includes at least one of: moving a region of the complex control flow region into a generated if statement region; moving the region of the complex control flow region into an existing if statement region; or moving the region of the complex control flow region into an if statement region of a generated if statement.

In some aspects, the techniques described herein relate to a method, where transforming the complex control flow region based on the performed code motion includes: iteratively (a) performing a plurality of code motions of the complex control flow region based on a plurality of determinations that the set of complex inefficient instruction blocks includes non-isomorphic regions and is eligible for transformation and (b) transforming the complex control flow region including at least one code motion of the plurality of code motions.

In some aspects, the techniques described herein relate to a method, where simplifying the control flow of the complex control flow region includes: simplifying the control flow of the transformed complex control flow region based on a determination that the iterations exceed a threshold limit; or simplifying the control flow of the transformed complex control flow region based on a determination that the transformed complex control flow region reached a steady state.

In some aspects, the techniques described herein relate to a method of optimizing a control flow graph, including: obtaining the control flow graph, where the control flow graph includes a set of instruction blocks; identifying a set of inefficient instruction blocks including a set of redundant instructions based on the obtained control flow graph; determining a set of complex inefficient instruction blocks including non-isomorphic regions that are eligible for a transformation based on the identified set of complex inefficient instruction blocks; performing code motion on a complex control flow region of the control flow graph based on the determined set of complex inefficient instruction blocks; transforming the complex control flow region based on the code motion; simplifying a control flow of the transformed complex control flow region; and fusing a first redundancy portion and a second redundancy portion of the control flow graph based on the simplified control flow.

In some aspects, the techniques described herein relate to a method, further including: compiling a representation of source code based on the control flow graph including the fused first redundancy portion and the second redundancy portion; and executing the compiled representation of source code.

In some aspects, the techniques described herein relate to a method, performing code motion of the complex control flow region of the control flow graph based on the determined set of complex inefficient instruction blocks includes at least one of: hoisting code outside the complex control flow region; sinking code into the complex control flow region; or factoring code in the complex control flow region.

In some aspects, the techniques described herein relate to a method, where performing code motion of the complex control flow region of the control flow graph based on the determined set of complex inefficient instruction blocks includes at least one of: moving a region of the complex control flow region based on divergent branches of the complex control flow region; moving the region of the complex control flow region based on early termination constructs of the complex control flow region; moving the region of the complex control flow region based on a register footprint of the complex control flow region; moving the region of the complex control flow region based on an instruction count of the complex control flow region; moving the region of the complex control flow region based on a locality sensitivity of the complex control flow region; moving the region of the complex control flow region based on a latency sensitivity of the complex control flow region; or moving the region of the complex control flow region based on an elementary functional unit (EFU) grouping of the complex control flow region.

In some aspects, the techniques described herein relate to a method, where transforming the complex control flow region based on the code motion includes at least one of: moving a region of the complex control flow region into a generated if statement region; moving the region of the complex control flow region into an existing if statement region; or moving the region of the complex control flow region into an if statement region of a generated if statement.

In some aspects, the techniques described herein relate to a method, where transforming the complex control flow region based on the code motion includes: iteratively (a) performing a plurality of code motions of the complex control flow region based on a plurality of determinations that the set of complex inefficient instruction blocks includes non-isomorphic regions and is eligible for transformation and (b) transforming the complex control flow region including at least one code motion of the plurality of code motions.

In some aspects, the techniques described herein relate to a method, where simplifying the control flow of the transformed complex control flow region includes: simplifying the control flow of the transformed complex control flow region based on a determination that the iterations exceed a threshold limit; or simplifying the control flow of the transformed complex control flow region based on a determination that the transformed complex control flow region reached a steady state.

In some aspects, the techniques described herein relate to a method, where simplifying the control flow of the transformed complex control flow region includes: reducing a plurality of exit outputs of the control flow of the transformed complex control flow region to a single exit output.

In some aspects, the techniques described herein relate to a method, where fusing the first redundancy portion and the second redundancy portion of the control flow graph based on the simplified control flow includes: fusing the first redundancy portion and the second redundancy portion of the control flow graph based on the simplified control flow in response to a determination that the first redundancy portion and the second redundancy portion reached a steady state.

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example of eliminating redundant code in a representation of source code utilizing tail merging, in accordance with one or more techniques of this disclosure.

FIG. 4 illustrates an example of eliminating redundant code in a representation of source code utilizing branch fusion, in accordance with one or more techniques of this disclosure.

FIG. 5 illustrates an example of eliminating redundant code in a representation of source code utilizing global common subexpression elimination (CSE), in accordance with one or more techniques of this disclosure.

FIG. 6 illustrates examples of complex non-isometric control flows including redundant code, in accordance with one or more techniques of this disclosure.

FIG. 7 illustrates an example of a complex control flow including non-isometric regions having redundant code, in accordance with one or more techniques of this disclosure.

FIG. 8 illustrates an example of integrated code motion atop control flow restructuring, in accordance with one or more techniques of this disclosure.

FIG. 9 is a flowchart of an example method of optimizing a control flow graph, in accordance with one or more techniques of this disclosure.

FIG. 10 illustrates examples of simple control flow regions, in accordance with one or more techniques of this disclosure.

FIG. 11 illustrates an example code motion within a control flow region, in accordance with one or more techniques of this disclosure.

FIG. 12 illustrates an example code motion within a control flow region, in accordance with one or more techniques of this disclosure.

FIG. 13 illustrates an example code motion within a control flow region, in accordance with one or more techniques of this disclosure.

FIG. 14 illustrates an example code motion within a control flow region, in accordance with one or more techniques of this disclosure.

FIG. 15 illustrates an example code motion within a control flow region, in accordance with one or more techniques of this disclosure.

FIG. 16 illustrates an example code motion within a control flow region, in accordance with one or more techniques of this disclosure.

FIG. 17 illustrates an example code motion within a control flow region, in accordance with one or more techniques of this disclosure.

FIG. 18 illustrates an example code motion within a control flow region, in accordance with one or more techniques of this disclosure.

FIG. 19 illustrates an example of fusing simple control flow regions, in accordance with one or more techniques of this disclosure.

FIG. 20 illustrates an example of fusing simple control flow regions, in accordance with one or more techniques of this disclosure.

FIG. 21 illustrates an example of fusing simple control flow regions, in accordance with one or more techniques of this disclosure.

FIG. 22 is a call flow diagram illustrating example communications between a CPU and a GPU in accordance with one or more techniques of this disclosure.

FIG. 23 is a flowchart of an example method of optimizing a control flow graph, in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

A computer program, for example a game or a compute shader, may be represented by a control flow graph—a representation of the possible execution paths within a program, where each node of the control flow graph represents a basic block of code, and each edge between the nodes represents the flow of control between those blocks. Redundant code of the computer program may be eliminated via an optimization technique performed on the control flow graph. For example, tail merging may optimize redundant code by merging two sets of redundant code at a tail end of parallel control flow regions of a control flow graph. A control flow graph optimizer may deem an expression E2 redundant if E2 computes a value V along a control flow path, and is preceded by and equivalent expression E1 that also computes the same value V. In other words, the expression E2 may be replaced by using the value V instead of performing the computation a second time. A control flow graph optimizer may determine that an expression E2 is fully redundant if the value V computed by the expression E1 is available on all paths through the program entry point to the expression, or may determine that an expression E2 is partially redundant if the value V computed by the expression E1 is available on some paths, but not all paths, through the program entry point to the expression.

When a control flow graph has isomorphic control flow regions, it may be easier to identify and optimize redundant code. Isomorphic control flow regions are regions of a control flow graph that have identical shapes or identical nests and sequences. The identical shapes may include, for example, a single basic block, a triangular set of edges and nodes, or a diamond-shaped set of edges and nodes. Isomorphic control flow regions may have similar structures, which have identical shapes but different instruction sequences. However, a control flow graph may have a control flow region that includes non-isomorphic regions that include different shapes (i.e., different forms of branches), different nests, and/or different sequences. Such non-isomorphic regions may include redundant code, but it may be difficult to identify and optimize such redundant code using an automated system. Identifying and optimizing redundant code is even more difficult for non-isomorphic control flow regions which are complex. A complex control flow region may have a shape that does not have a single entry and a single exit. Such complex control flow regions may feature redundant code within a branch, across different branches with identical shapes, or across different branches with different shapes. A compiler's front end may generate redundant code in non-isomorphic complex control flow regions during a conversion of array addressing expressions into machine instructions, and/or during different levels of intermediate code transformations. For example, games and compute shaders may be rife with complex control flow regions that have different forms of branches, different forms of nests, and different sequences. However, such complex control flow regions may include redundant instructions, for example within a branch, across different branches with similar structures, or across branches with distinct structures.

In some examples, a processor (e.g., a graphics processor, a graphics processor system, a compiler processor system) may optimize a control flow graph. Optimization of a control flow graph may include eliminating redundant code and/or instructions. Optimization of a control flow graph may include eliminating instruction sequences of a program. The processor may obtain a control flow graph. For example, the processor may obtain the control flow graph from a component of a system, or may generate the control flow graph as part of a compiler process. For example, a compiler's front end may generate an intermediate representation of source code, and may then organize that intermediate representation of source code as a control flow graph and identify relevant nodes and edges. The control flow graph may include a set of instruction blocks. An instruction block may include a portion of a line of a representation of source code, a full line of a representation of source code, or a plurality of lines of a representation of source code. For example, a set of instruction blocks may include ten instructions, where eight instructions of the ten instructions are redundant. A single instruction may be referred to as a basic instruction block, which is unable to be broken down further into a plurality of instructions. The processor may identify a set of inefficient instruction blocks that include a set of redundant instructions based on the obtained control flow graph. In other words, the processor may identify instruction blocks with redundant instructions or may identify instruction blocks with redundant instruction sequences. An instruction sequence may be a plurality of instructions in an instruction block where each instruction of the plurality of instructions is executed in a specific order. An inefficient instruction block may be a block of instructions that include at least one redundant instruction or instruction sequence.

The processor may determine a set of complex inefficient instruction blocks that include non-isomorphic regions that are eligible for a transformation based on the identified set of complex inefficient instruction blocks. A complex inefficient instruction block may be a complex control flow region of a control flow graph that includes an inefficient instruction block. A complex control flow region is a control flow region of a control flow graph that does not have a single entry and a single exit. A simple control flow region is a control flow region of a control flow graph that has a single entry and a single exit. Two non-isomorphic regions are control flow regions that do not have an identical shapes or that do not have identical nests and sequences. Two complex inefficient instruction blocks that are eligible for a transformation are instruction blocks that have redundant code and that satisfy a transformation condition. Instruction blocks that do not satisfy a transformation condition may include, for example, whether the two instruction blocks straddle a synchronization barrier, whether the two instruction blocks belong to different data-locality groups, whether the two instruction blocks belong to different memory-latency groups, or whether the two instruction blocks straddle an early-termination construction. A synchronization barrier may be a point of synchronization between parallel threads. A data-locality group may include a common long synchronization queue or a common data buffer. A memory-latency group may include store instructions or load instructions that have durations within a threshold period of time of one another. An early-termination construction may include an instruction to prematurely terminate a loop sequence (e.g., a for loop, a while loop) based on a condition being satisfied.

The processor may perform code motion on a complex control flow region of the control flow graph based on the determined set of complex inefficient instruction blocks. Code motion includes a movement of code from one region of a control flow graph to another region of the control flow graph. Code motion may move any number of redundant instructions based on value equivalence of expressions. However, code motion may not be used with redundancies that contain slight value differences. The processor may transform the complex control flow region based on the code motion. For example, the processor may transform an instruction block having a data dependency into an instruction block having a control dependency. The processor may simplify a control flow of the complex control flow region. In other words, the processor may modify the complex control flow region that does not have a single entry and a single exit to be a simple control flow region that has a single entry and a single exit. The processor may fuse a first redundancy portion and a second redundancy portion of the control flow graph based on the simplified control flow. Fusing redundancy portions may include incorporating subsections of the second redundancy portion in the first redundancy portion and deleting the second redundancy portion, or incorporating subsections of the first redundancy portion in the second redundancy portion and deleting the first redundancy portion.

The processor may obtain the control flow graph by generating an intermediate representation of source code based on a set of raw source code. The processor may obtain the control flow graph by organizing the generated intermediate representation of source code into a control flow graph having a set of nodes and a set of edges. The processor may compile a representation of source code based on the control flow graph, which includes the fused first redundancy portion and the second redundancy portion. In other words, the processor may compile the optimized source code. The processor may execute the compiled representation of source code. To perform code motion of the complex control flow region of the control flow graph based on the determined set of complex inefficient instruction blocks, the processor may hoist code outside the complex control flow region, sink code into the complex control flow region, or factor code in the complex control flow region. Hoisting code outside a complex control flow region may include moving variable and function declarations to the top of their scope before executing the code. Hoisting code outside a complex control flow region may also include moving computations above the control flow regions. Sinking code into a complex control flow region, may include optimizing code by moving instructions into branches where the instructions are used. Factoring code in a complex control flow region may include restructuring source code to change the internal structure of the code without altering the behavior of the source code. The code motion may improve the internal structure and readability of the source code without altering the behavior of the source code. To perform code motion of the complex control flow region of the control flow graph based on the determined set of complex inefficient instruction blocks, the processor may (a) move a region of the complex control flow region based on divergent branches of the complex control flow region, (b) move the region of the complex control flow region based on early termination constructs of the complex control flow region, (c) move the region of the complex control flow region based on a register footprint of the complex control flow region, (d) move the region of the complex control flow region based on an instruction count of the complex control flow region, (e) move the region of the complex control flow region based on a locality sensitivity of the complex control flow region, (f) move the region of the complex control flow region based on a latency sensitivity of the complex control flow region, and/or (g) move the region of the complex control flow region based on an elementary functional unit (EFU) grouping of the complex control flow region. An EFU may include math functions, such as log, sine, cosine, and an exponential function. An EFU may also be referred to as a special functional unit (SFU).

To transform the complex control flow region based on the code motion, the processor may (a) move a region of the complex control flow region into a generated if statement region, (b) move the region of the complex control flow region into an existing if statement region, and/or (c) move the region of the complex control flow region into an if statement region of a generated if statement. An if statement region may include a set of instructions on a path of an if statement, for example the true path of the if statement or the false path of the if statement. To transform the complex control flow region based on the code motion, the processor may iteratively (a) perform a plurality of code motions of the complex control flow region based on a plurality of determinations that the set of complex inefficient instruction blocks that include non-isomorphic regions and is eligible for transformation and (b) transform the complex control flow region that includes at least one code motion of the plurality of code motions. The processor may perform the iterations until the complex control flow region reaches a steady state. A steady state occurs when a control flow region does not change from one iteration to the next iteration. To simplify the control flow of the complex control flow region, the processor may simplify the control flow of the complex control flow region based on a determination that the iterations exceed a threshold limit or simplify the control flow of the complex control flow region based on a determination that the complex control flow region reached a steady state. To simplify the control flow of the complex control flow region, the processor may reduce a plurality of exit outputs of the control flow of the complex control flow region to a single exit output. To simplify the control flow of the complex control flow region, the processor may reduce a plurality of entry inputs of the control flow of the complex control flow region to a single entry input. To fuse the first redundancy portion and the second redundancy portion of the control flow graph based on the simplified control flow, the processor may fuse the first redundancy portion and the second redundancy portion of the control flow graph based on the simplified control flow in response to a determination that the first redundancy portion and the second redundancy portion reached a steady state.

In some aspects, a control flow graph optimizer may discover and minimize redundancies in a control flow graph by: (a) identifying qualified regions for redundancy checks and elimination, (b) performing constant propagation and revert if-conversion, (c) employing uniformity analysis to identify divergent/uniform branches, (d) employing enhanced global value numbering (GVN) to partition values into different congruence classes, (e) enhanced code motion within and across simple control-flow subgraphs in the control flow graph, (f) simplifying complex control-flow subgraphs in the control flow graph into simple control-flow subgraphs, (g) fusing simple control-flow subgraphs to minimize or eliminate redundancies amidst such regions, and/or (h) applying if-conversion if deemed beneficial.

Particular aspects of the subject matter described in this disclosure can be implemented to realize one or more of the following potential advantages. In some examples, by performing enhanced code motion on complex control flow blocks having non-isomorphic regions that are eligible for transformation, the described techniques can be used to eliminate redundant code and/or redundant instructions in a representation of source code.

A compiler may be configured to use a control flow graph optimizer to eliminate redundancies in a representation of source code. In some aspects, the compiler may first process raw source code to generate an intermediate representation of source code, and then utilize the control graph optimizer to eliminate redundancies in the source code before compiling and executing a computer program. The control graph optimizer may use common sub-expression elimination, loop-variant code motion, partial-redundancy elimination, tail merging, and/or branch fusion. However, such common redundancy elimination techniques may fail to discover and optimize redundancies that exist in non-isomorphic complex control flow regions. In other words, two control flow regions that do not have identical sequences and that do not have a single entry and a single exit may have redundancies that may not be eliminated using common redundancy elimination techniques. A control flow graph optimizer may be configured to eliminate redundancies in non-isomorphic complex control flow regions by performing a static analysis to identify both partial and full redundancies in non-isomorphic complex control-flow regions, and perform compiler transformations that optimize such redundancies. Such control flow graph optimizers may reduce dynamic instruction account and/or may reduce the path length to convergence.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

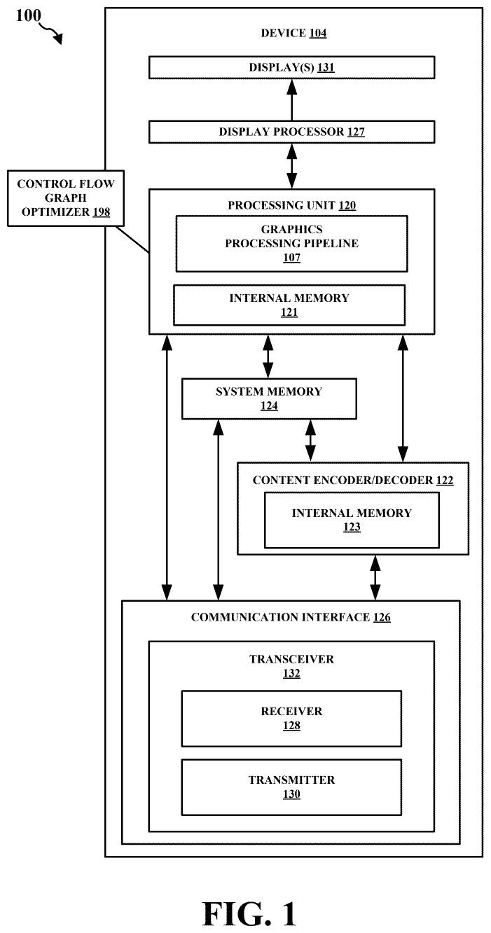

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a control flow graph optimizer 198 configured to obtain a control flow graph. The control flow graph may include a set of instruction blocks. The control flow graph optimizer 198 may be configured to identify a set of inefficient instruction blocks that include a set of redundant instructions based on the obtained control flow graph. The control flow graph optimizer 198 may be configured to determine a set of complex inefficient instruction blocks that include non-isomorphic regions that are eligible for a transformation based on the identified set of complex inefficient instruction blocks. The control flow graph optimizer 198 may be configured to perform code motion on a complex control flow region of the control flow graph based on the determined set of complex inefficient instruction blocks. The control flow graph optimizer 198 may be configured to transform the complex control flow region based on the code motion. The control flow graph optimizer 198 may be configured to simplify a control flow of the complex control flow region based on the performed code motion. The control flow graph optimizer 198 may be configured to fuse a first redundancy portion and a second redundancy portion of the control flow graph based on the simplified control flow. Although the following description may be focused on optimizing a control flow graph with a graphics processor, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

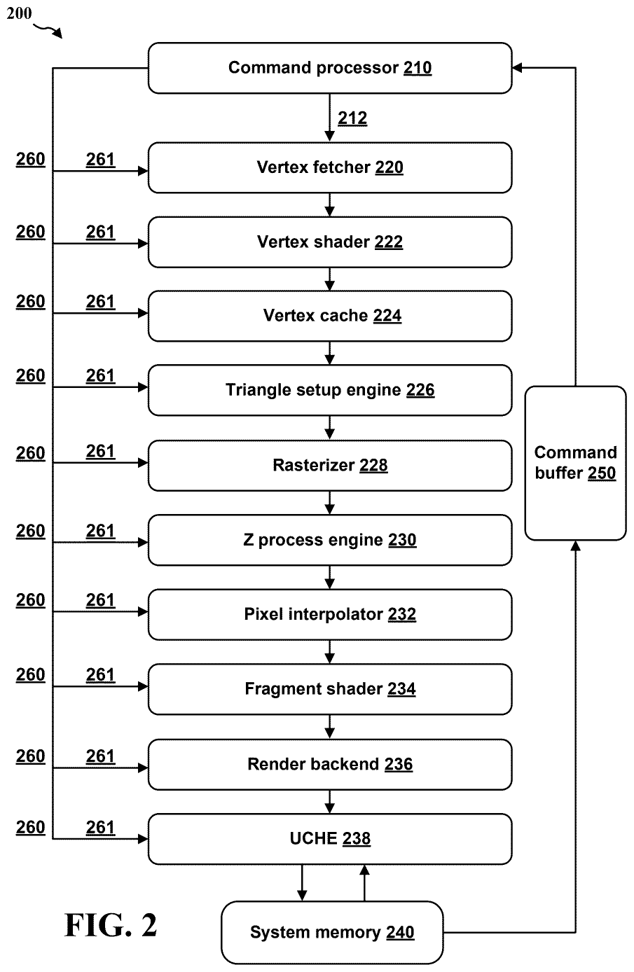

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

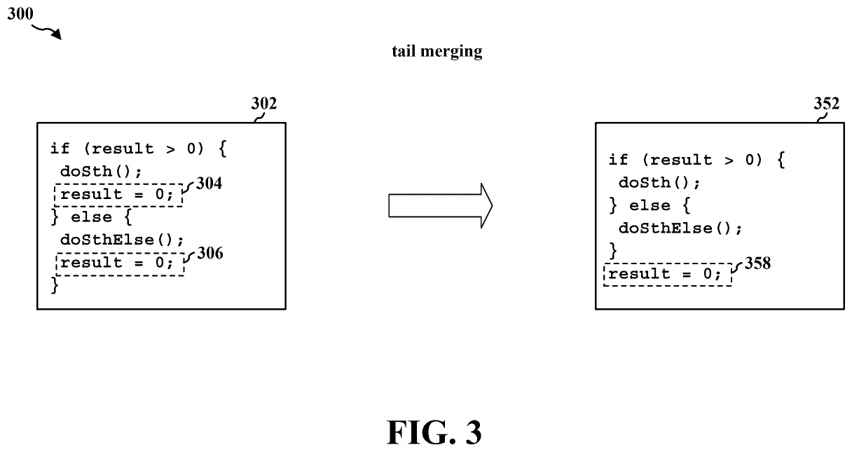

FIG. 3 is a diagram 300 illustrating an example of eliminating redundant code in a representation of source code 302 utilizing tail merging. The representation of source code 302 may include pseudocode that illustrates an if-else statement that includes a first redundancy portion 304 and a second redundancy portion 306. The first redundancy portion 304 and the second redundancy portion 306 may be identical. The first redundancy portion 304 and the second redundancy portion 306 may be isomorphic. The first redundancy portion 304 and the second redundancy portion 306 may be fused via tail merging to form the merged portion 358 of the optimized representation of source code 352. The representation of source code 352 may be functionally equivalent to the representation of source code 302, but may be optimized to use less resources at compilation time. Tail merging may be used to eliminate redundancies in control flow graphs having triangle or diamond shapes with identical instructions. While tail merging may merge identical sequences of instructions in branches into a separate block and introduce an early jump to that block, tail merging may not be used for other types of redundancies, such as non-isomorphic complex control-flows.

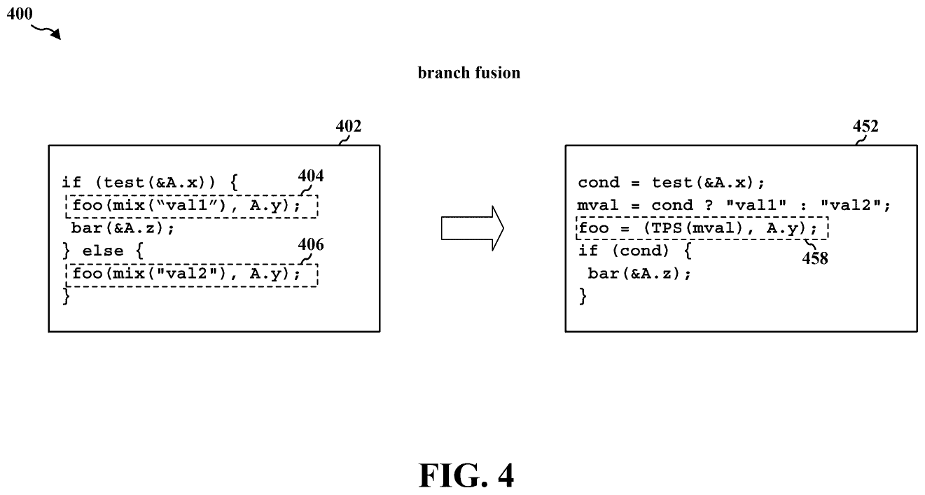

FIG. 4 is a diagram 400 illustrating an example of eliminating redundant code in a representation of source code 402 utilizing branch fusion. The representation of source code 402 may include pseudocode that illustrates an if-else statement that includes a first redundancy portion 404 and a second redundancy portion 406. The first redundancy portion 404 and the second redundancy portion 406 may not be identical. However, the first redundancy portion 404 and the second redundancy portion 406 may be isomorphic, as they have the same identical shape of a basic block calling a function. The first redundancy portion 404 and the second redundancy portion 406 may be fused via branch merging to form the merged portion 458 of the optimized representation of source code 452. The merged portion 458 may leverage the newly defined variables “cond” and “mval,” which may be used to call the merged function in the merged portion 458. The representation of source code 452 may be functionally equivalent to the representation of source code 402, but may be optimized to use less resources at compilation time. Branch fusion may be used to eliminate redundancies in control flow graphs having triangle or diamond shapes with identical instructions, and triangle or diamond shapes with distinct instructions that are operationally equivalent. While branch fusion may merge pairs of instructions based on operation equivalence, branch fusion may not be used for other types of redundancies, such as redundancies that do not come in pairs or non-isomorphic complex control-flows.

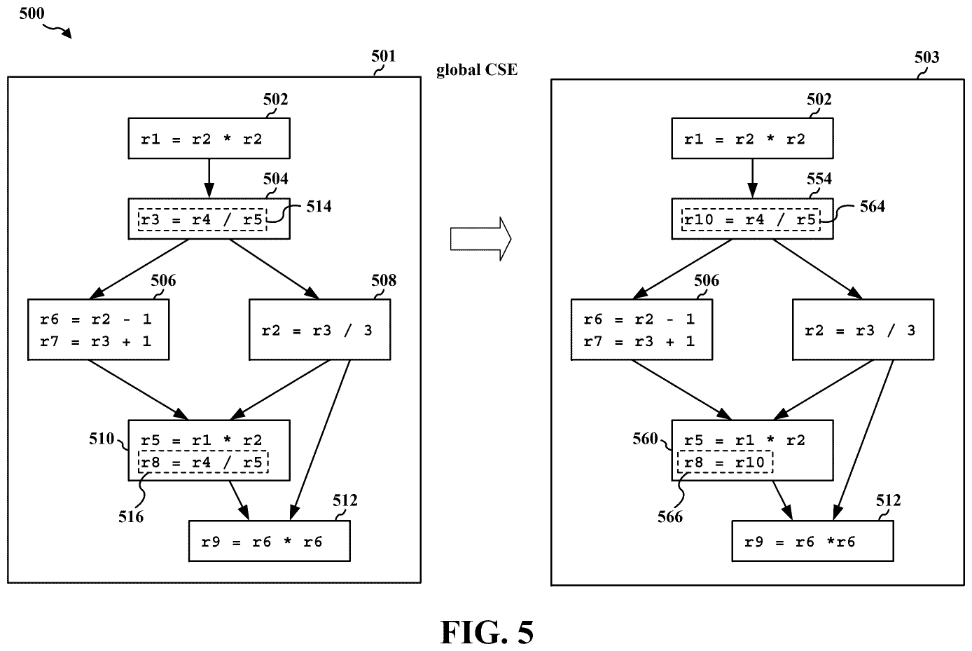

FIG. 5 is a diagram 500 illustrating an example of eliminating redundant code in a representation of source code 501 utilizing global common subexpression elimination (CSE). The representation of source code 501 may include pseudocode that illustrates a sequence of instructions executed by a program. The representation of source code 501 may be referred to as a control flow graph having nodes 502, 504, 506, 508, 510, and 512 joined by logical edges that illustrate the control flow of the representation of source code 501. The node 504 may have a first redundancy portion 514 and the node 510 may have a second redundancy portion 516. The first redundancy portion 514 and the second redundancy portion 516 may not be identical. However, the first redundancy portion 514 and the second redundancy portion 516 may be isomorphic, as they have the same identical shape of a basic block performing the same computation with the same variables. The first redundancy portion 514 and the second redundancy portion 516 may be fused via global CSE by defining the new variable r10 with the source code portion 564 in the revised node 554, which is then referred to by the source code portion 566 in the revised code 560. The representation of source code 503 may be functionally equivalent to the representation of source code 501, but may be optimized to use less resources at compilation time.

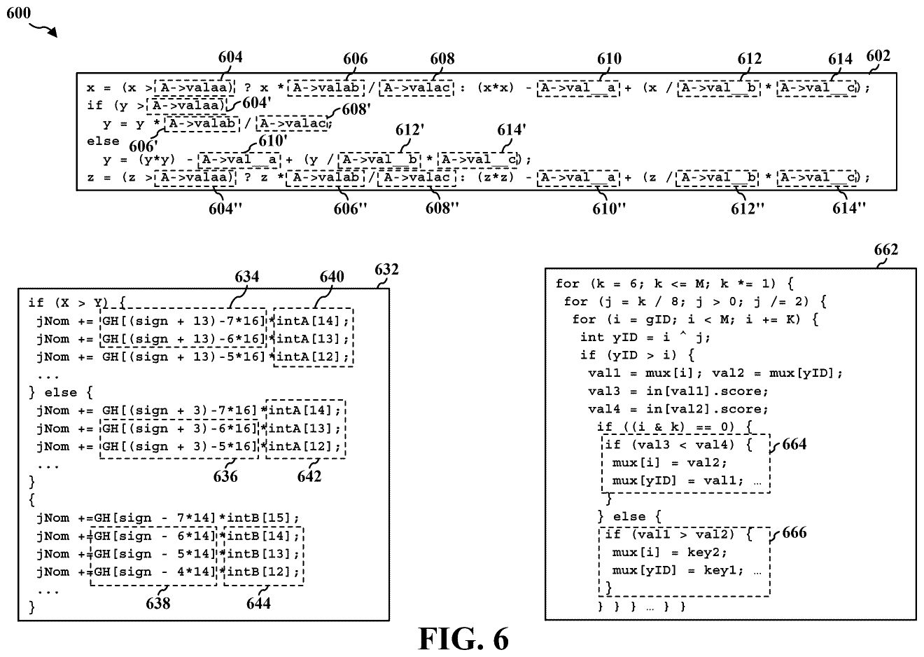

FIG. 6 is a diagram 600 that illustrates examples of complex non-isometric control flows that include redundant code, in accordance with one or more techniques of this disclosure. The representation of source code 602 includes a control flow region 604, a control flow region 604′, and a control flow region 604″ that shares redundant code. Similarly, the representation of source code 602 includes a control flow region 606, a control flow region 606′, and a control flow region 606″ that shares redundant code. Similarly, the representation of source code 602 includes a control flow region 608, a control flow region 608′, and a control flow region 608″ that shares redundant code. Similarly, the representation of source code 602 includes a control flow region 610, a control flow region 610′, and a control flow region 610″ that shares redundant code. Similarly, the representation of source code 602 includes a control flow region 612, a control flow region 612′, and a control flow region 612″ that shares redundant code. Similarly, the representation of source code 602 includes a control flow region 614, a control flow region 614′, and a control flow region 614″ that shares redundant code. However, these redundancies exist across different if-else blocks, and not the if-else block of a common control region. As a result, common code motion optimization techniques, such as basic code motion, branch fusion, and/or tail merging, used by processors may not be able to detect such redundancies.

Similarly, the representation of source code 632 includes a control flow region 634 and a control flow region 636 within an if-else statement that shares redundant code with a control flow region 638 within a join point after the if-else statement. Similarly, the representation of source code 632 includes a control flow region 640 and a control flow region 642 within the if-else statement that shares redundant code with a control flow region 644 within the join point after the if-else statement. As these redundancies do not exist within the same if-else block, common code motion optimization techniques used by processors may not be able to detect such redundancies.

Similarly, the representation of source code 662 includes a control flow region 664 that shares redundant code with a control flow region 666 within the same if-else statement. However, as these redundancies exist across a large block of instructions, common code motion optimization techniques used by processors that analyze individual lines and not blocks of instructions may not be able to detect such redundancies.

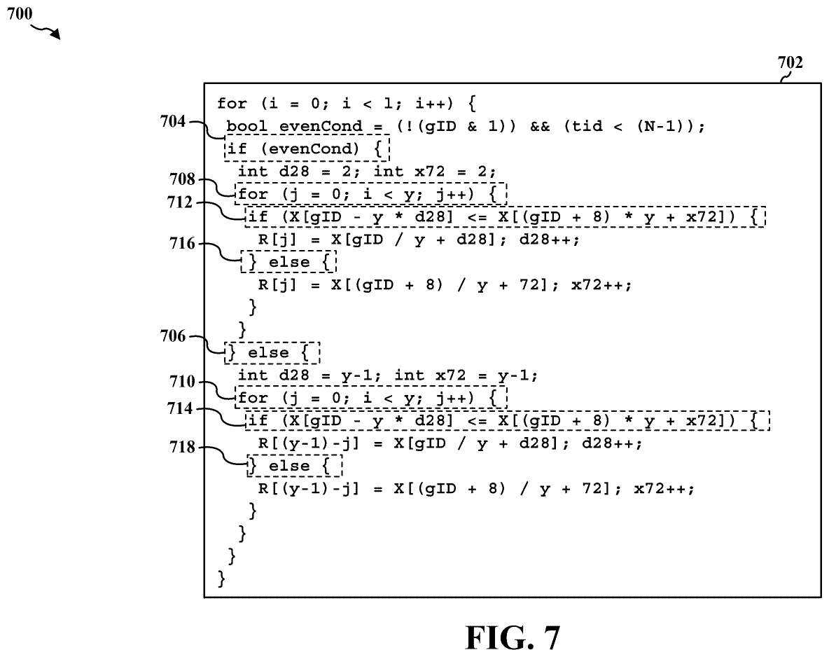

FIG. 7 is a diagram 700 that illustrates examples of complex non-isometric control flows that include redundant code, in accordance with one or more techniques of this disclosure. The representation of source code 702 may have an if-else block represented by the if instruction within the control flow region 704 and the else instruction within the control flow region 706 that have similar sequences of instructions (i.e., the same shape in a control flow graph). For example, the for loop in the control flow region 708 shares a similar sequence to the for loop in the control flow region 710, the if statement in the control flow region 712 shares a similar sequence to the if statement in the control flow region 714, and the else statement in the control flow region 716 shares a similar sequence to the else statement in the control flow region 718. However, as these redundancies exist across a large block of instructions, common code motion optimization techniques used by processors that analyze individual lines and not blocks of instructions may not be able to detect such redundancies.

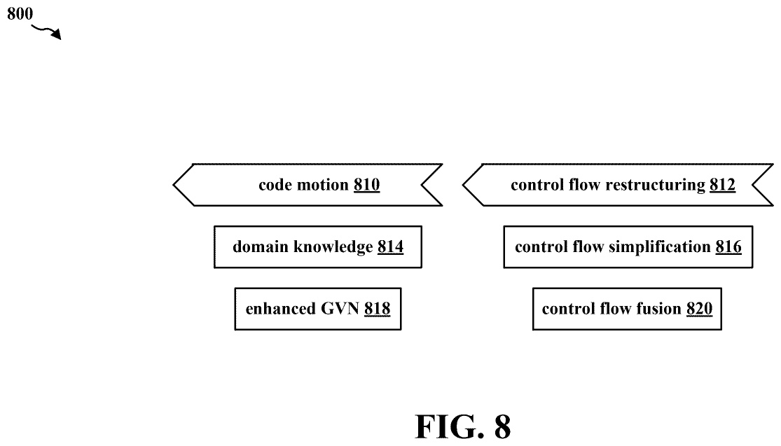

FIG. 8 is a diagram 800 that illustrates an example of integrated code motion on top of control flow restructuring, in accordance with one or more techniques of this disclosure. A control flow graph optimizer, such as the control flow graph optimizer 198 in FIG. 1, may apply code motion 810 on top of control flow restructuring 812. When applying the code motion 810, the control flow graph optimizer may leverage domain-specific knowledge 814 to perform enhanced global value numbering (GVN) 818. When performing control flow restructuring 812, the control flow graph optimizer may perform both control flow simplification 816 and control flow fusion 820. By leveraging domain-specific knowledge 814 to perform enhanced GVN 818 and then perform control flow simplification 816 and control flow fusion 820, a control flow graph optimizer may identify and optimize redundancies in representations of source code, such as those redundancies illustrated in FIGS. 6 and 7. A control graph optimizer may leverage both value and operation equivalence at a global level to discover and optimize both partial and full redundancies within and across complex control-flow regions that are non-isomorphic. A control graph optimizer may be used to eliminate redundancies in control flow graphs having triangle or diamond shapes with identical instructions, triangle or diamond shapes with distinct instructions that are operationally equivalent, identical instructions within complex control flow graphs, or non-isomorphic operationally equivalent instructions across complex control flow graphs.

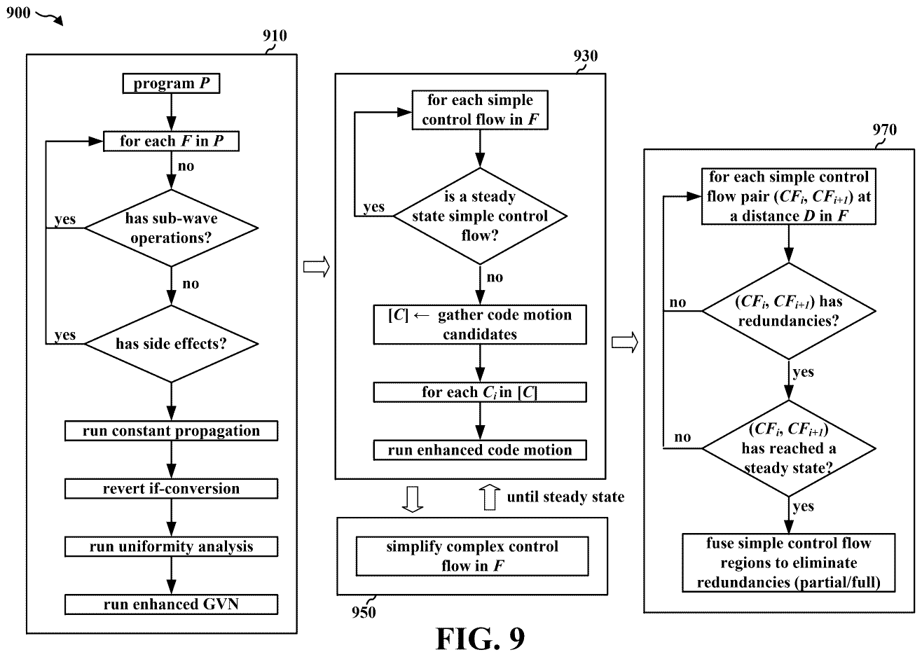

FIG. 9 is a flowchart 900 of an example method of optimizing a control flow graph, in accordance with one or more techniques of this disclosure. Given a high-level, or an intermediate representation of a program, a control graph optimizer may perform a static analysis for discovering partial and full redundancies in the presence of complex non-isomorphic control flow regions, and perform code transformations for redundancy elimination. Underpinning these approaches are enhancements to code motion and global value numbering (GVN) techniques that incorporate domain-specific knowledge (e.g., from games and compute applications), and the semantics of underlying programming languages and application programming interfaces (APIs). A cost model incorporating target specific micro architectural details and the characteristics of candidate redundant expressions for optimization may yield selective code motions and control flow fusions.

At 910, a control flow graph optimizer may perform preparatory analysis and transformations. At 910, the control flow graph optimizer may obtain a program P, such as a representation of source code. The control flow graph optimizer may, for each function F (e.g., a set of instruction blocks) in program P, determine whether the function F have sub-wave operations. Sub-wave functions operate on groups of work items (e.g., fibers) within a wave. They may be used for synchronized data exchange amongst a subset of fibers in a wave, and for synchronizing a subset of fibers within a wave and for providing memory fence. Vendor-specific implementations of sub-wave functions may not guarantee independent forward progress. Redundancy elimination through global code motion and control-flow fusion in the presence of sub-wave operations may cause deadlocks. Hence, the control flow graph optimizer may preclude proposed transformations in functions containing sub-wave operations. The control flow graph optimizer may, for each function F in program P that do not have sub-wave operations, determine if the function F has any side effects. The control flow graph optimizer may deem the function F to not have any side effects if the function F performs a function on a set of input arguments and does not affect the value of any of the input arguments. The control flow graph optimizer may deem the function F to have side effects if the function F accepts an argument as an input and changes a value of at least one of the input arguments. The control flow graph optimizer may deem the function F to have side effects if the function F accepts a display stream as an input and writes a produced value to the display screen. In summary, for each function F in program P, the control flow graph optimizer may identify qualified regions for redundancy checks and elimination to identify functions that do not have sub-wave operations or side effects.

At 910, the control flow graph optimizer may run constant propagation on any eligible functions F. Constant propagation may be a precursor to reverse if-conversion and may create more opportunities for reverse if-conversion. By transforming control dependencies into data dependencies, if-conversion may remove control-flow subgraphs in a control flow graph. The control flow graph optimizer may employ reverse if-conversion to expose more control-flow subgraphs for redundancy elimination.

At 910, the control flow graph optimizer may employ uniformity analysis to identify divergent branches and uniform branches. The control flow graph optimizer may determine that a variable whose value differs for different threads in a wave to be divergent, and a variable whose value remains the same for different threads in a wave to be uniform. For example, the control flow graph optimizer may determine a thread identifier to be a divergent variable. Data divergence may result in memory divergence and control flow divergence. The control flow graph optimizer may determine that threads in a wave that follow different paths after processing the same branch to have control flow divergence. The control flow graph optimizer may determine that a load or a store instruction that accesses data divergent addresses to have memory divergence. By identifying uniform branches, the control flow graph optimizer may identify redundant code that may be eliminated in a transformation.

At 910, the control flow graph optimizer may perform enhanced GVN to partition expressions into equivalence classes by value. Such equivalence classes may also be referred to as congruence classes. The control flow graph optimizer may deem two values to be congruent if they are computed by the same operator and its operands are congruent. The control flow graph optimizer may enhance GVN with additional criteria to ensure the legality and profitability of proposed transformations. The control flow graph optimizer may deem two expressions to be incongruent, despite their value equivalence, if they (i) straddle a barrier, (ii) belong to different data-locality groups, (iii) belong to different memory-latency queues, and/or (iv) straddle an early-termination construct, such as discard in fragment shaders, and break in loops.

At 930, the control flow graph optimizer may perform a first stage of transformations. The first stage of transformations may include enhanced code motion within and across simple control flow subgraphs in the control flow graph of the program P. For each simple control flow in the function F, the control flow graph optimizer may determine whether the control flow is a steady state simple control flow. If yes, the control flow graph optimizer may forward the function F to perform the third stage of transformations at 970. If no, the control flow graph optimizer may gather code motion candidates. The control flow graph optimizer may identify computations that are dominated by definitions from the same congruence class. The control flow graph optimizer may deem fully redundant expressions in both paths of an if-else branch candidates for hoisting to a common predecessor. Similarly, the control flow graph optimizer may deem expressions in a convergent region above a branch that are used in one side of the branch candidates for sinking into the branch. The control flow graph optimizer may also run enhanced code motion on the identified computations. The control flow graph optimizer may incorporate one or more of code hoisting, code sinking, and code factoring in order to improve program performance. The control flow graph optimizer may employ following safety and profitability criteria in addition to traditional pre-requisites for code motion. For example, the control flow graph optimizer may preclude code motion into divergent branches. The control flow graph optimizer may preclude hoisting code above early termination constructs, such as discard, continue and break. The control flow graph optimizer may preclude code motion if the resulting register footprint exceeds the prior peak footprint. The control flow graph optimizer may enforce temporaries and speculative execution of some instructions for hoisting and/or sinking. In other words, the control flow graph optimizer may preclude hoisting and/or sinking if it increases instruction count above a certain threshold. This may be in view of potential impact on inlining, unrolling, and instruction cache capacity. The control flow graph optimizer may enable code motion of memory instructions belonging to a latency group in their entirety or none at all. In other words, the control flow graph optimizer may prevent introducing additional memory-access latencies. The control flow graph optimizer may enable code motion of locality-sensitive group of memory-accesses either in entirety or none at all. The control flow graph optimizer may enable code motion of a sub-set of EFU instructions belonging to the same latency queue if the number of delay slots introduced is within acceptable limit for the given hardware. Enhanced code motion may include employing any combination of the aforementioned safety and profitability criteria when performing the code motion.

At 950, the control flow graph optimizer may perform a second stage of transformation. The second stage of transformation may simplify complex control flow subgraphs in the control flow graph into simple control flow subgraphs. A simple region, or sub-graph, in a control flow graph may have (a) a single-entry single-exit basic block, (b) a triangle control flow branch with a single entry and a single exit, (c) a diamond control-flow branch with a single entry and a single exit where true and false branches do not dominate each other, or (d) a region whose sub-regions are all simple regions. A complex region, or sub-graph, in a control flow graph may be any region that is not simple. The control flow graph optimizer may simplify the complex control flow to have a single entry and a single exit. For example, a region with a set of entries E and a set of exits X can be transformed into a simple region by introducing new entry and exit blocks A, B. All successors of E may be moved to A and A may then be made the single successor of E. All predecessors of X may be moved to B and a single exit edge may be added from B to X. In some aspects, the first and second stage of transformations at 930 and at 950 may be iteratively performed until a steady state is reached. In some aspects, the first and second stage of transformations at 930 and at 950 may be iteratively performed until an iteration limit threshold is reached (e.g., 5 iterations, 10 iterations), even if a steady state has not been reached.

At 970, the control flow graph optimizer may perform a third stage of transformations. The third stage of transformations may fuse simple control flow subgraphs to minimize or eliminate redundancies amidst the subgraphs. The fusion may include applying if-conversion if deemed beneficial. For each simple control flow pair within a distance D, which may be a defined threshold value, the control flow graph optimizer may identify if two simple control flow pairs contain redundancies. For example, identical structures and identical instructions, or distinct structures and identical instructions, or distinct structures and duplicate instructions. A user may adjust the value of the distance D for efficiency, as a large value of D may influence the control flow graph optimizer to consider a prohibitively large number of simple control flow pairs. The control flow graph optimizer may then fuse the simple control flow regions after the simple control flow pairs reach a steady state. In some aspects, the control flow graph optimizer may fuse the simple control flow regions in response to the simple control flow pairs reaching the steady state. For example, consider two single entry single exit simple control-flow regions with subgraphs S1 and S2 in the true (T) and false (F) paths respectively. The control flow graph optimizer may consider two subgraphs to be fused if: (i) S1 and S2 include solely of single basic blocks, or (ii) one of S1 and S2 is a single block simple control-flow region and the other includes a multi-block simple region. In some aspects, the control flow graph optimizer may apply if-conversion if beneficial. For example, the control flow graph optimizer may convert some data dependencies to control dependencies for exposing redundancy elimination opportunities. For example, the control flow graph optimizer may apply tail merging and branch fusion are if-conversion techniques to a control flow graph region having a fused region if the if-conversion would result in a reduced dynamic instruction count. By operating at the level of both individual basic blocks and subgraphs of program P, the control flow graph optimizer may discover and minimize redundancies across control structures having redundancies in non-isomorphic complex control flow subgraphs.

In another aspect, a control flow graph optimizer may remove redundancies from a program P by applying the following pseudocode to the representation of the program P:
for each F in P, do
   if hasSubWaveOps(F)||hasSideEffects(F) then
      continue
   runConstantPropagaion
   revertIfConversion
   runUniformityAnalysis
   runEnhancedGVN
repeat
   for each simpleCF do
      C{1₁, . . . Iₙ}=gatherCMCandidates
      for each Cᵢ in C do
         runEnhancedCodeMotion(Cᵢ)
until steady state
repeat
   for each pair CFᵢ, CFᵢ₊₁ at a distance D do
      if containRedundancies(CFᵢ, CFᵢ₊₁) then
         fuseSimpleCFlows(CFᵢ, CFᵢ₊₁)
until steady state

Where the program P may be a user program having a set of functions F and a set of instructions I, where each code motion candidate may be expressed as a block of instructions C{1₁, . . . Iₙ}. The program P may be raw source code, or an intermediate representation (IR) of source code generated by a compiler that includes redundancies. The output of the pseudocode may be a representation of the program P that is functionally equivalent, but which includes fewer redundancies. The function hasSubWaveOps(F) may refer to a function that returns true if the function F has sub-wave operations, and returns false if the function F does not have sub-wave operations. The function hasSideEffects(F) may refer to a function that returns true if the function F has side effects, and returns false if the function F does not have side effects. The function runConstantPropagaion may refer to a step of replacing constant variables with a constant in response to a determination that the value of a variable at a given control state in a program is a constant value. The function revertIfConversion may refer to a step of transforming control dependencies into data dependencies to expose more control flow subgraphs for redundancy elimination. The function runUniformityAnalysis may refer to a step of determining which variables remain the same for different threads in a wave to identify redundant code. The function runEnhancedGVN may refer to a step of partitioning expressions into equivalence classes by value (e.g., congruence classes). The term simpleCF refers to a simple control flow region in a given function F. The function gatherCMCandidates may refer to the step of determining what blocks of instructions in the given control flow region may be candidates for code motion, for example fully redundant expressions in both paths of an if-else branch or expressions in a convergent region above a branch that are used in one side of the branch and not the other side of the branch. The function runEnhancedCodeMotion(Cᵢ) may refer to the step of performing enhanced code motion on the candidate Cᵢ, for example hoisting code, sinking code, and/or factoring code using safety and profitability criteria (e.g., precluding code motion into divergent branches, enabling code motion of a sub-set of EFU instructions belonging to the same latency queue so long as the number of delay slots introduced is within a threshold limit associated with a hardware processor). The function containRedundancies(CFᵢ, CFᵢ₊₁) may refer to the step of determining if the simple control flow pair (CFᵢ, CFᵢ₊₁) has any redundancies. The function fuseSimpleCFlows(CFᵢ, CFᵢ₊₁) may refer to the step of fusing the simple control flow pair (CFᵢ, CFᵢ₊₁) in response to a determination that the control flow pair has redundancies.

Referring back to the representation of source code 602, the redundancies span across three predicated regions of code: the line 1, the lines 2-5, and the line 6. A control flow graph optimizer may apply the method shown in flowchart 900 in FIG. 9 to convert data dependencies into control dependencies, iteratively search through control-flow regions at various levels and distance for redundancies, and employ cost heuristics to drive code motion across such regions. These analyses and transformations together may be consequential in eliminating the redundancies. The control flow graph optimizer may hoist the redundancies up the code and re-use the redundancies across assignments in the three control-flow regions. For example, the control flow graph optimizer may hoist the expression “A—>valaa” from the control flow region 604 and assign that expression to the variable “var1,” and then use the variable “var1” in place of the control flow region 604, control flow region 604′, and the control flow region 604″.

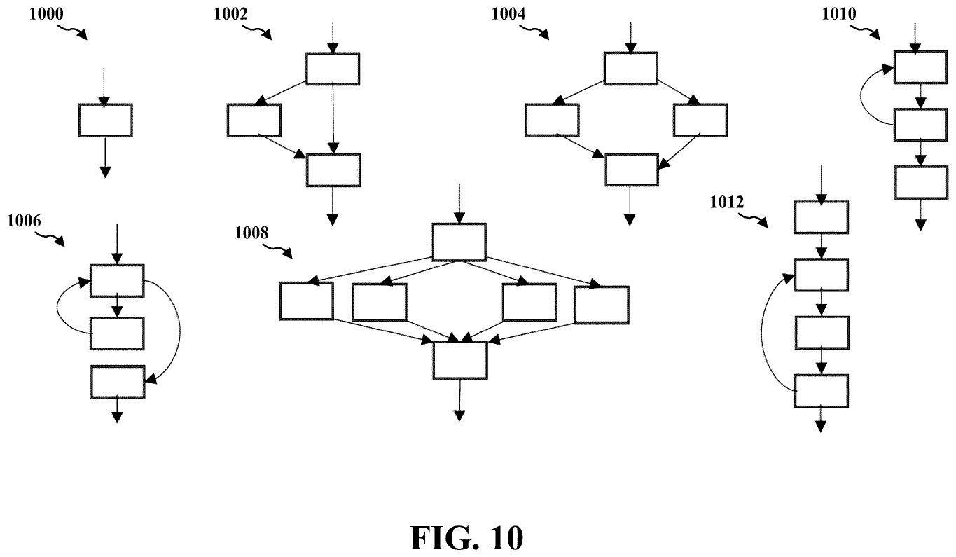

FIG. 10 includes diagrams 1000, 1002, 1004, 1006, 1008, 1010, and 1012 of simple control flow regions, in accordance with one or more techniques of this disclosure. The diagram 1000 illustrates a basic block of straight line code having a single entry and a single exit. The diagram 1002 illustrates an if-then block, also referred to as a triangular shaped code. The diagram 1004 illustrates an if-then-else block, also referred to as a diamond-shaped code. The diagram 1006 illustrates a do loop. The diagram 1008 illustrates a do-while loop. The diagram 1010 illustrates a case statement. The diagram 1010 illustrates a for loop.

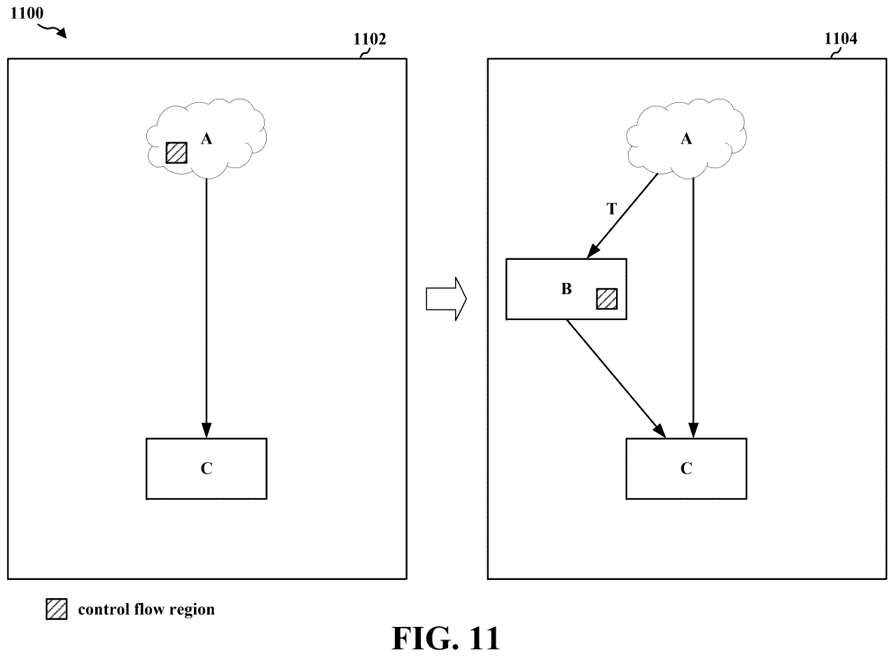

FIG. 11 is a diagram 1100 of an example code motion within a control flow region 1102, in accordance with one or more techniques of this disclosure. The control flow region 1102 may have an instruction block A with a control flow region that may include a redundant piece of code that may be moved to a side path for optimization. The control flow region 1102 may have an instruction block C with an edge that connects instruction block A and instruction block C. A control flow graph optimizer may generate an if-then statement having an instruction block B, and may move the control flow region including the redundant piece of code into the instruction block B along the if path, resulting in the representation of source code 1104. In other words, the control flow graph optimizer may move the control flow region including the redundant piece of code into a generated if statement region.

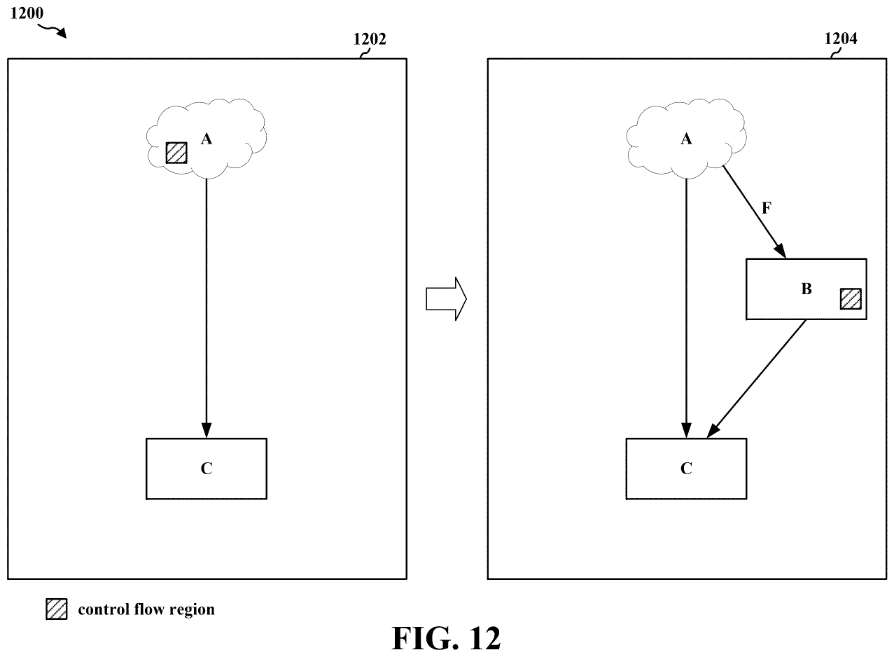

FIG. 12 is a diagram 1200 of an example code motion within a control flow region 1202, in accordance with one or more techniques of this disclosure. The control flow region 1202 may have an instruction block A with a control flow region that may include a redundant piece of code that may be moved to a side path for optimization. The control flow region 1202 may have an instruction block C with an edge that connects instruction block A and instruction block C. A control flow graph optimizer may generate an if-else statement having an instruction block B, and may move the control flow region including the redundant piece of code into the instruction block B along the else path, resulting in the representation of source code 1204. In other words, the control flow graph optimizer may move the control flow region including the redundant piece of code into a generated if statement region, which includes an else branch.

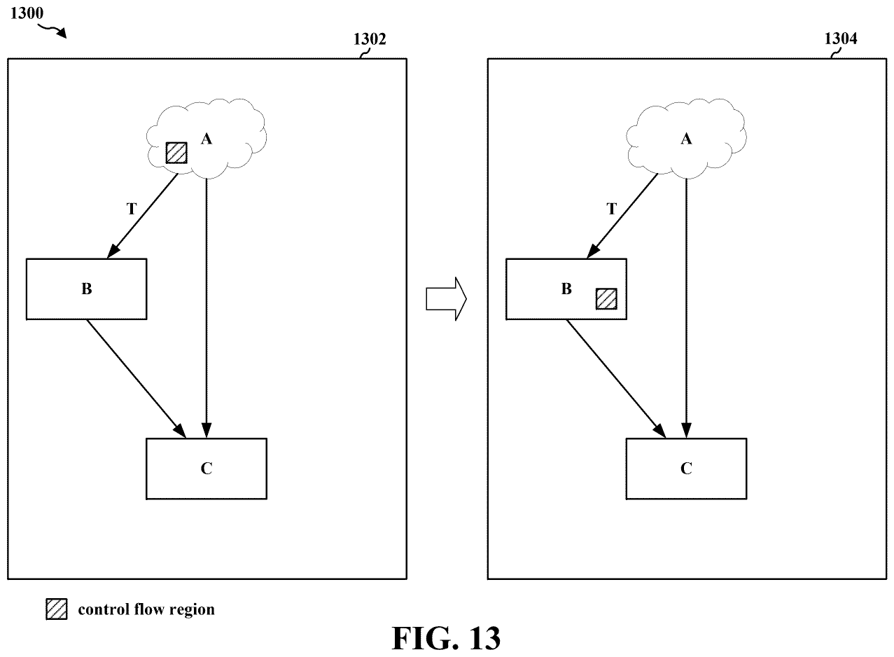

FIG. 13 is a diagram 1300 of an example code motion within a control flow region 1302, in accordance with one or more techniques of this disclosure. The control flow region 1302 may have an instruction block A with a control flow region that may include a redundant piece of code that may be moved to a side path for optimization. The control flow region 1302 may have an instruction block C and an instruction block B with edges that connects the instruction blocks. A control flow graph optimizer may move the control flow region including the redundant piece of code into the instruction block B along the if path, resulting in the representation of source code 1304. In other words, the control flow graph optimizer may move the control flow region including the redundant piece of code into an existing if statement region.

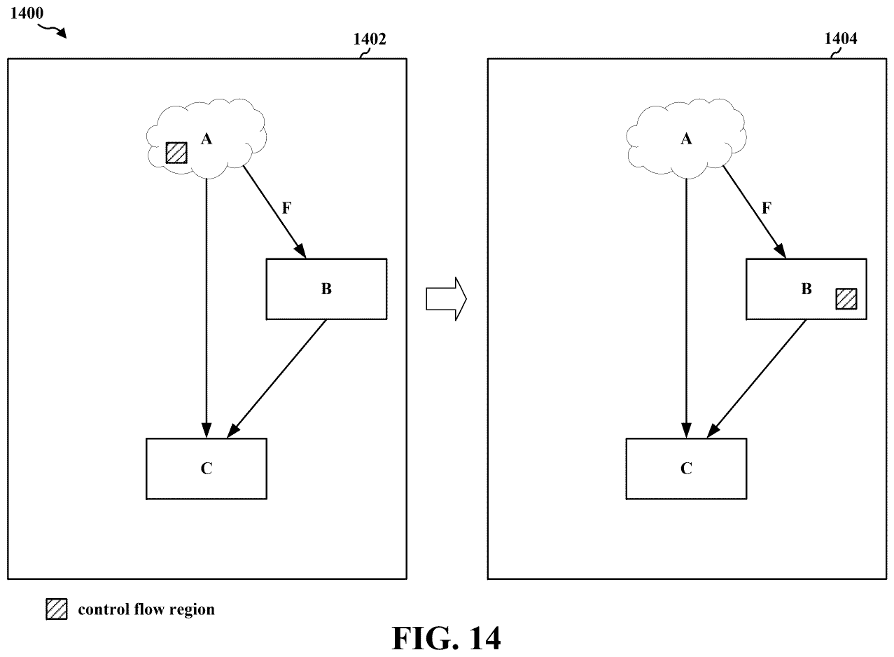

FIG. 14 is a diagram 1400 of an example code motion within a control flow region 1402, in accordance with one or more techniques of this disclosure. The control flow region 1402 may have an instruction block A with a control flow region that may include a redundant piece of code that may be moved to a side path for optimization. The control flow region 1402 may have an instruction block C and an instruction block B with edges that connects the instruction blocks. A control flow graph optimizer may move the control flow region including the redundant piece of code into the instruction block B along the else path, resulting in the representation of source code 1404. In other words, the control flow graph optimizer may move the control flow region including the redundant piece of code into an existing if statement region, which is an existing else branch of the if statement.

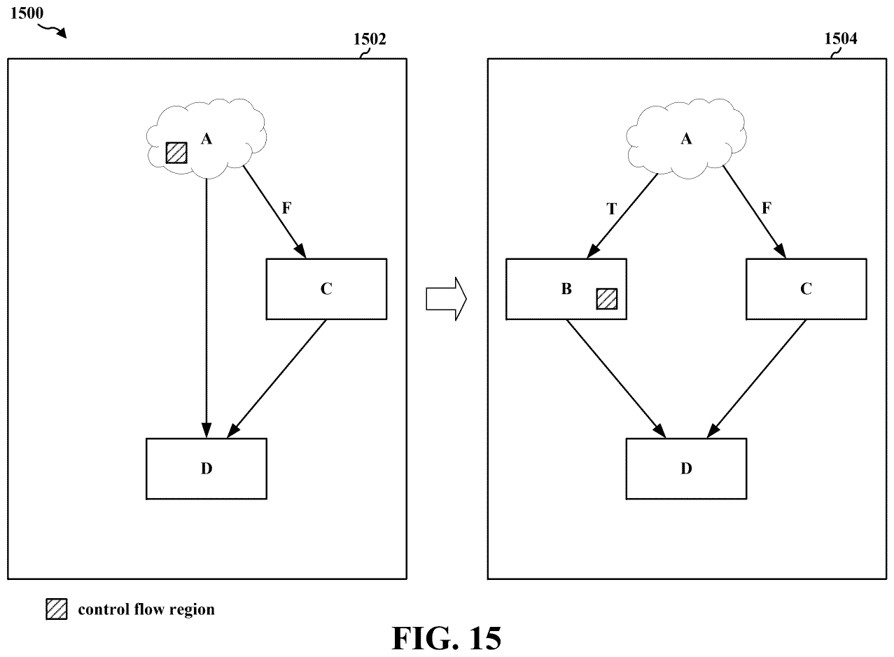

FIG. 15 is a diagram 1500 of an example code motion within a control flow region 1502, in accordance with one or more techniques of this disclosure. The control flow region 1502 may have an instruction block A with a control flow region that may include a redundant piece of code that may be moved to a side path for optimization. The control flow region 1502 may have an instruction block C and an instruction block D with edges that connects the instruction blocks. A control flow graph optimizer may generate an instruction block B along an if path of an if-else statement, and then may move the control flow region including the redundant piece of code into the instruction block B along the else path, resulting in the representation of source code 1504. In other words, the control flow graph optimizer may move the control flow region including the redundant piece of code into a generated if statement region of an existing if statement.

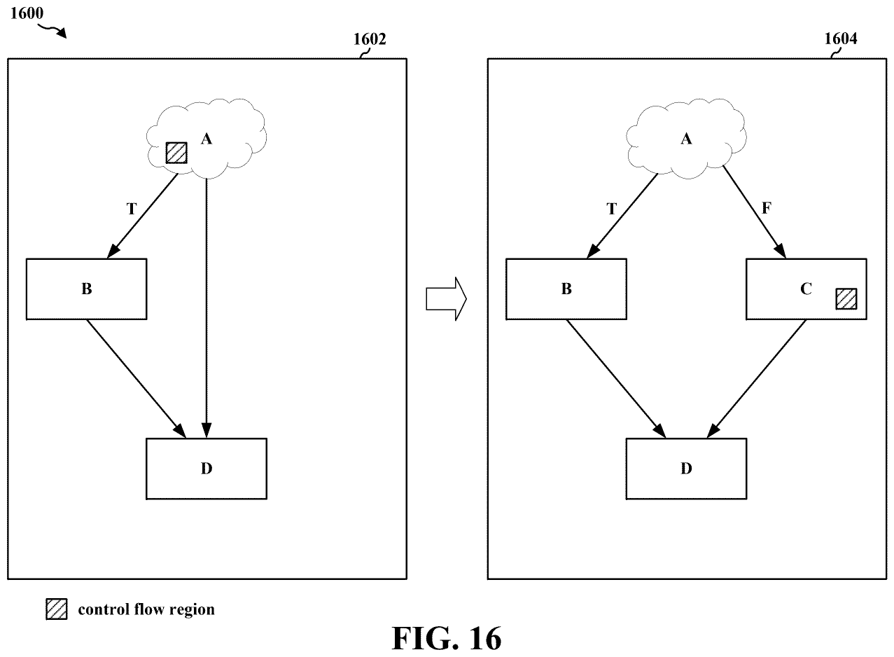

FIG. 16 is a diagram 1600 of an example code motion within a control flow region 1602, in accordance with one or more techniques of this disclosure. The control flow region 1602 may have an instruction block A with a control flow region that may include a redundant piece of code that may be moved to a side path for optimization. The control flow region 1602 may have an instruction block B and an instruction block D with edges that connects the instruction blocks. A control flow graph optimizer may generate an instruction block C along an else path of an if-else statement, and then may move the control flow region including the redundant piece of code into the instruction block C along the else path, resulting in the representation of source code 1604. In other words, the control flow graph optimizer may move the control flow region including the redundant piece of code into a generated if statement region of an existing if statement, which is the else statement region of the existing if statement.

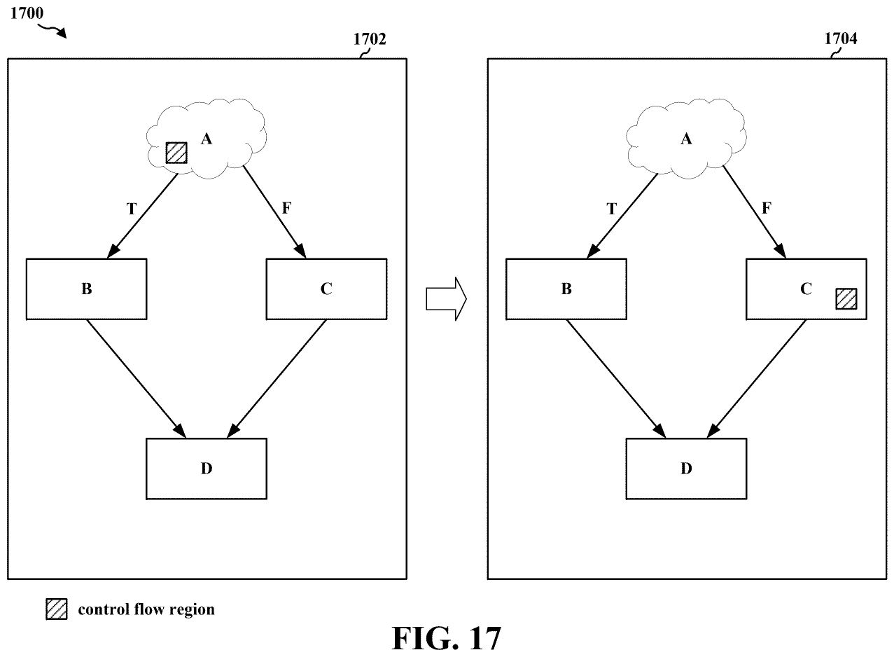

FIG. 17 is a diagram 1700 of an example code motion within a control flow region 1702, in accordance with one or more techniques of this disclosure. The control flow region 1702 may have an instruction block A with a control flow region that may include a redundant piece of code that may be moved to a side path for optimization. The control flow region 1702 may have an instruction block B, an instruction block C, and an instruction block D with edges that connects the instruction blocks. A control flow graph optimizer may move the control flow region including the redundant piece of code into the instruction block C along the else path, resulting in the representation of source code 1704. In other words, the control flow graph optimizer may move the control flow region including the redundant piece of code into an existing if statement region of an existing if statement, which is the else statement region of the existing if-else statement.

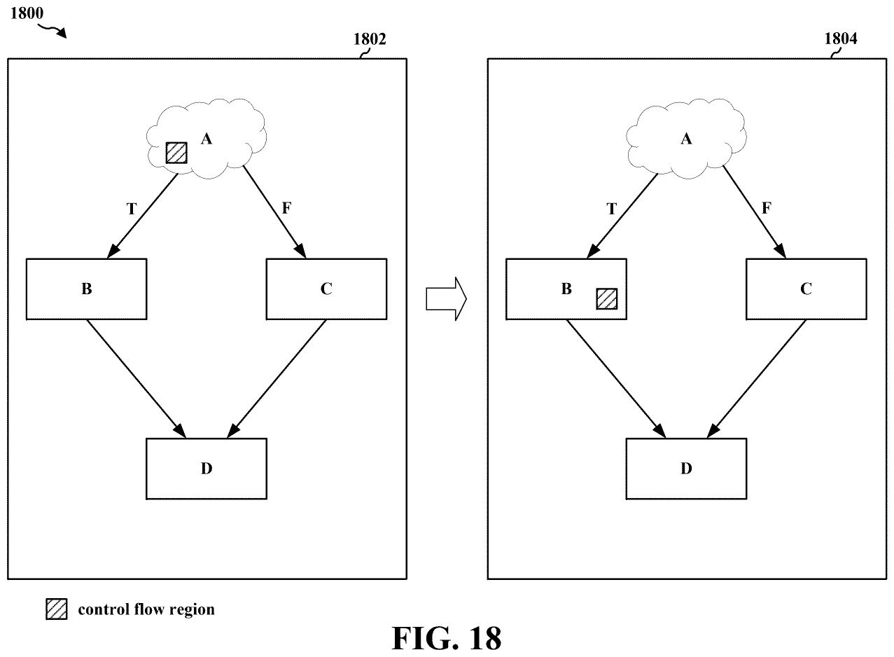

FIG. 18 is a diagram 1800 of an example code motion within a control flow region 1802, in accordance with one or more techniques of this disclosure. The control flow region 1802 may have an instruction block A with a control flow region that may include a redundant piece of code that may be moved to a side path for optimization. The control flow region 1802 may have an instruction block B, an instruction block C, and an instruction block D with edges that connects the instruction blocks. A control flow graph optimizer may move the control flow region including the redundant piece of code into the instruction block B along the if path, resulting in the representation of source code 1804. In other words, the control flow graph optimizer may move the control flow region including the redundant piece of code into an existing if statement region of an existing if statement, which is the if statement region of the existing if-else statement.

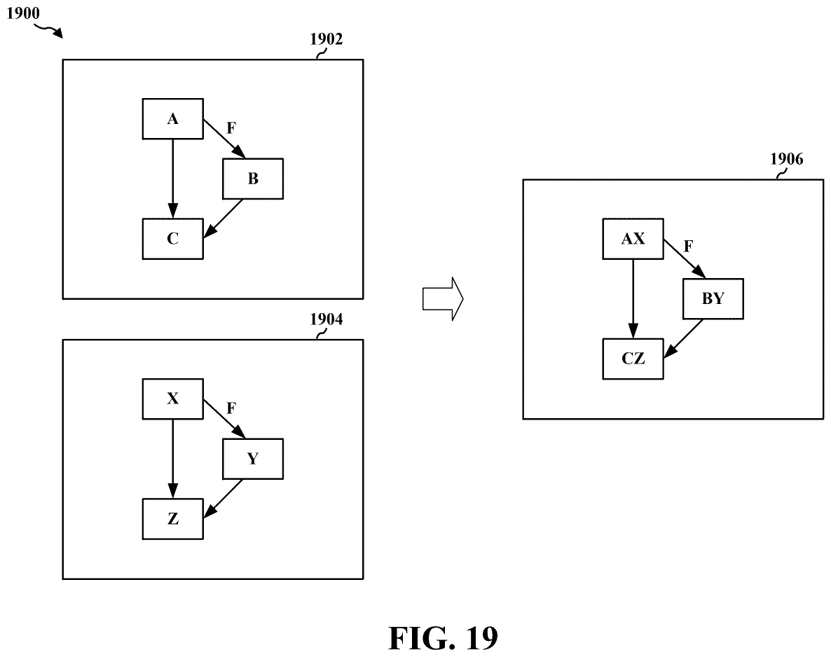

FIG. 19 is a diagram 1900 that illustrates an example of fusing simple control flow regions, in accordance with one or more techniques of this disclosure. Here, the control flow region 1902 and the control flow region 1904 may include identical code. A control flow graph optimizer may fuse the control flow region 1902 and the control flow region 1904 to generate the control flow region 1906 having the fused logic.

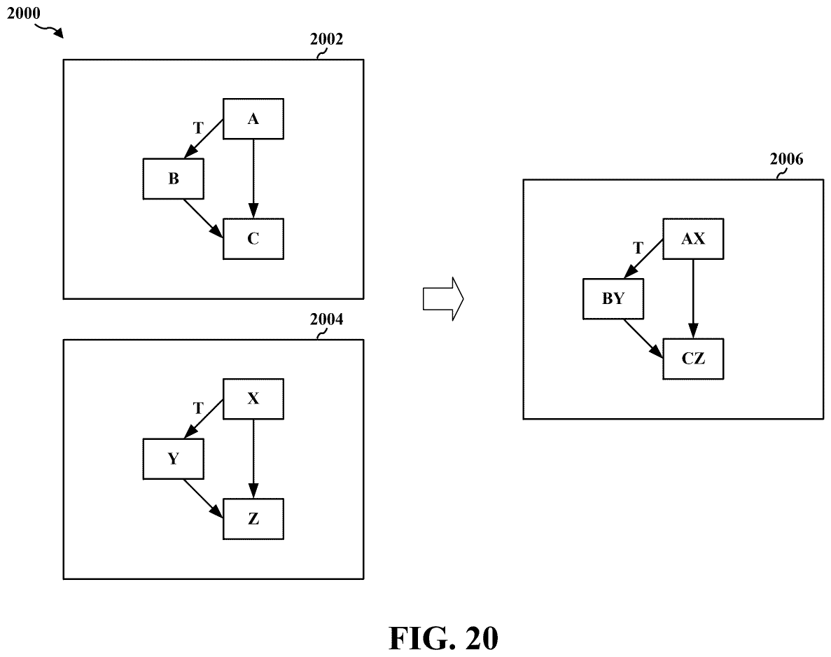

FIG. 20 is a diagram 2000 that illustrates an example of fusing simple control flow regions, in accordance with one or more techniques of this disclosure. Here, the control flow region 2002 and the control flow region 2004 may include identical code. A control flow graph optimizer may fuse the control flow region 2002 and the control flow region 2004 to generate the control flow region 2006 having the fused logic.

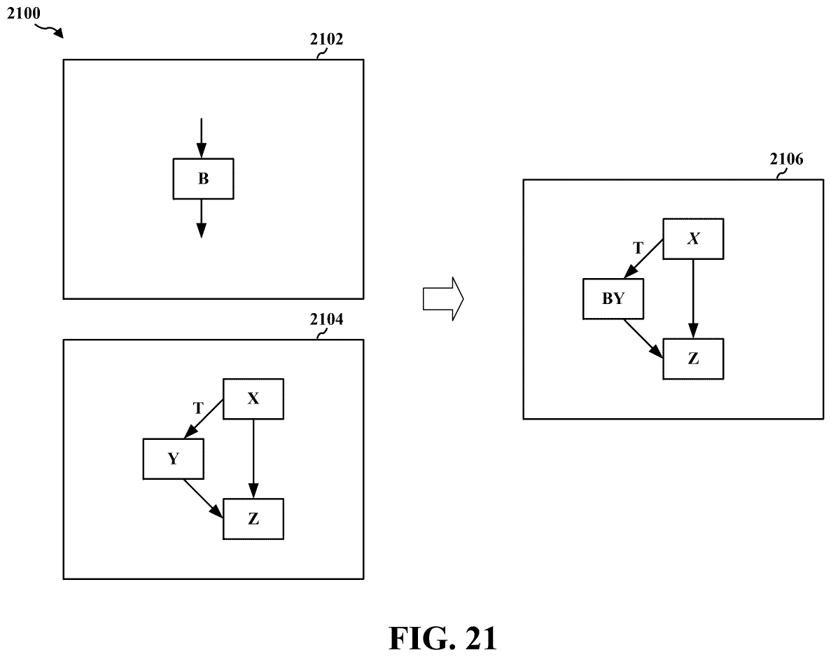

FIG. 21 is a diagram 2100 that illustrates an example of fusing simple control flow regions, in accordance with one or more techniques of this disclosure. Here, the control flow region 2102 and the control flow region 2104 may be isomorphic. For example, the control flow region 2102 may include a basic block of straight line code, while the control flow region 2104 may include an if-then statement. A control flow graph optimizer may fuse the control flow region 2102 and the control flow region 2104 to generate the control flow region 2106 having the fused logic at the if path of the if-then statement.

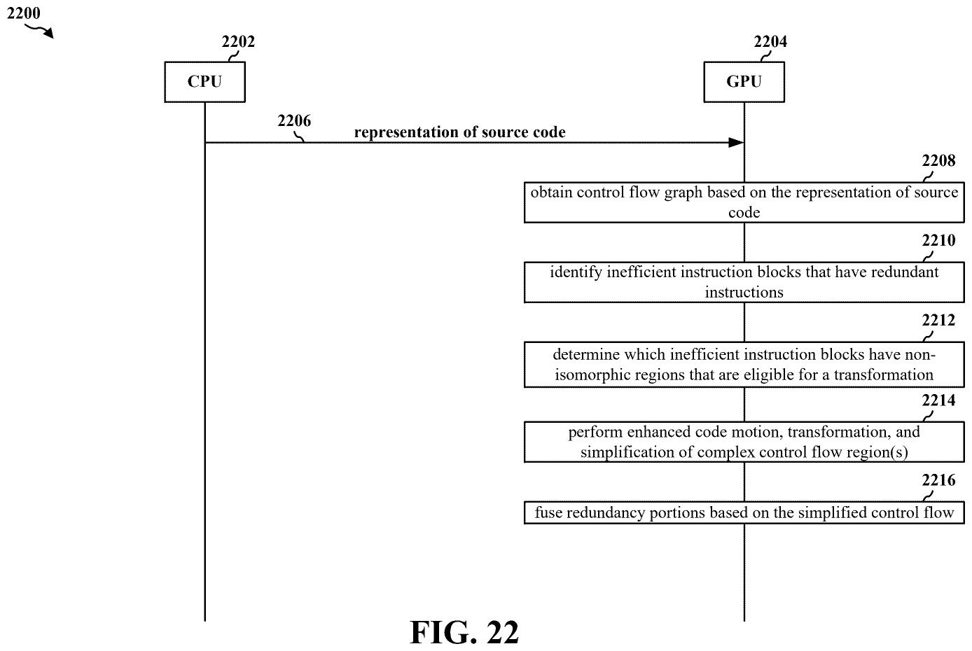

FIG. 22 is a call flow diagram 2200 illustrating example communications between a CPU 2202 and a GPU 2204 in accordance with one or more techniques of this disclosure. The CPU 2202 may output an indication 2206 of a representation of source code to the GPU 2204. For example, the CPU 2202 may output a set of source code for the GPU 2204 to compile and execute. At 2208, the GPU 2204 may obtain control flow graph based on the representation of source code. For example, the GPU 2204 may have a front-end compiler that generates an intermediate representation of source code, and then may organize the intermediate representation of source code to a control flow graph. In some aspects, the control flow graph may be graphical, whereas in other aspects the control flow graph may be any representation of a set of nodes and connecting edges that illustrate the shape of the control flow of the representation of source code. At 2210, the GPU 2204 may identify inefficient instruction blocks that have redundant instructions. At 2212, the GPU 2204 may determine which inefficient instruction blocks have non-isomorphic regions that are eligible for a transformation. At 2214, the GPU 2204 may perform enhanced code motion, transformation, and simplification of complex control flow region(s). At 2216, the GPU 2204 may fuse redundancy portions based on the simplified control flow.

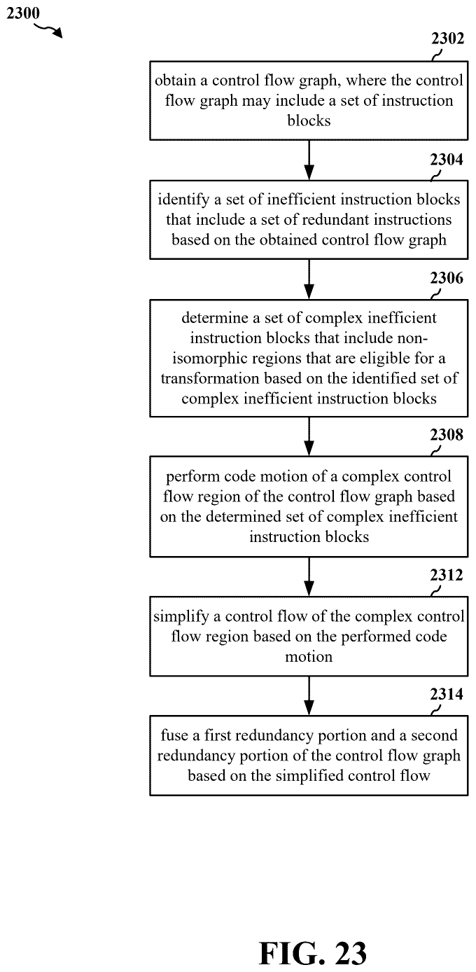

FIG. 23 is a flowchart 2300 of an example method of source code processing in accordance with one or more techniques of this disclosure. The method may be performed by an apparatus, such as an apparatus for source code processing or graphics processing, a GPU, a CPU, a wireless communication device, and the like, as used in connection with the aspects of FIGS. 1-22.

At 2302, the apparatus may obtain a control flow graph, where the control flow graph may include a set of instruction blocks. For example, in FIGS. 22, 2302 may be performed by the GPU 2204, which may obtain a control flow graph, where the control flow graph may include a set of instruction blocks. Moreover, 2302 may be performed by the control flow graph optimizer 198 in FIG. 1.

At 2304, the apparatus may identify a set of inefficient instruction blocks that include a set of redundant instructions based on the obtained control flow graph. For example, in FIGS. 22, 2304 may be performed by the GPU 2204, which may identify a set of inefficient instruction blocks that include a set of redundant instructions based on the obtained control flow graph. Moreover, 2304 may be performed by the control flow graph optimizer 198 in FIG. 1.

At 2306, the apparatus may determine a set of complex inefficient instruction blocks that include non-isomorphic regions that are eligible for a transformation based on the identified set of complex inefficient instruction blocks. For example, in FIGS. 22, 2306 may be performed by the GPU 2204, which may determine a set of complex inefficient instruction blocks that include non-isomorphic regions that are eligible for a transformation based on the identified set of complex inefficient instruction blocks. Moreover, 2306 may be performed by the control flow graph optimizer 198 in FIG. 1.

At 2308, the apparatus may perform code motion of a complex control flow region of the control flow graph based on the determined set of complex inefficient instruction blocks. For example, in FIGS. 22, 2308 may be performed by the GPU 2204, which may perform code motion of a complex control flow region of the control flow graph based on the determined set of complex inefficient instruction blocks. Moreover, 2308 may be performed by the control flow graph optimizer 198 in FIG. 1.

At 2312, the apparatus may simplify a control flow of the complex control flow region based on the performed code motion. For example, in FIGS. 22, 2312 may be performed by the GPU 2204, which may simplify a control flow of the complex control flow region based on the performed code motion. Moreover, 2312 may be performed by the control flow graph optimizer 198 in FIG. 1.

At 2314, the apparatus may fuse a first redundancy portion and a second redundancy portion of the control flow graph based on the simplified control flow. For example, in FIGS. 22, 2314 may be performed by the GPU 2204, which may fuse a first redundancy portion and a second redundancy portion of the control flow graph based on the simplified control flow. Moreover, 2314 may be performed by the control flow graph optimizer 198 in FIG. 1.

In configurations, a method or an apparatus for optimizing a control flow graph is provided. The apparatus may be a GPU, a CPU, or some other processor that may optimize control flow graphs, process source code, compile source code, or execute source code. In aspects, the apparatus may be the processing unit 120 within the device 104, or may be some other hardware within the device 104 or another device. The apparatus may include means for obtaining a control flow graph. The control flow graph may include a set of instruction blocks. The apparatus may further include means for identifying a set of inefficient instruction blocks that include a set of redundant instructions based on the obtained control flow graph. The apparatus may further include means for determining a set of complex inefficient instruction blocks that include non-isomorphic regions that are eligible for a transformation based on the identified set of complex inefficient instruction blocks. The apparatus may further include means for performing code motion on a complex control flow region of the control flow graph based on the determined set of complex inefficient instruction blocks. The apparatus may further include means for simplifying a control flow of the complex control flow region based on the performed code motion. The apparatus may further include means for fusing a first redundancy portion and a second redundancy portion of the control flow graph based on the simplified control flow.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.

Aspect 1 is a method of optimizing a control flow graph, comprising: obtaining the control flow graph, wherein the control flow graph comprises a set of instruction blocks; identifying a set of inefficient instruction blocks comprising a set of redundant instructions based on the obtained control flow graph; determining a set of complex inefficient instruction blocks comprising non-isomorphic regions that are eligible for a transformation based on the identified set of complex inefficient instruction blocks; performing code motion on a complex control flow region of the control flow graph based on the determined set of complex inefficient instruction blocks; transforming the complex control flow region based on the code motion; simplifying a control flow of the transformed complex control flow region; and fusing a first redundancy portion and a second redundancy portion of the control flow graph based on the simplified control flow.

Aspect 2 is the method of aspect 1, further comprising: compiling a representation of source code based on the control flow graph comprising the fused first redundancy portion and the second redundancy portion; and executing the compiled representation of source code.

Aspect 3 is the method of either of aspects 1 or 2, performing code motion of the complex control flow region of the control flow graph based on the determined set of complex inefficient instruction blocks comprises at least one of: code hoisting the complex control flow region; code sinking the complex control flow region; or code factoring the complex control flow region.

Aspect 4 is the method of any of aspects 1 to 3, wherein performing code motion of the complex control flow region of the control flow graph based on the determined set of complex inefficient instruction blocks comprises at least one of: moving a region of the complex control flow region based on divergent branches of the complex control flow region; moving the region of the complex control flow region based on early termination constructs of the complex control flow region; moving the region of the complex control flow region based on a register footprint of the complex control flow region; moving the region of the complex control flow region based on an instruction count of the complex control flow region; moving the region of the complex control flow region based on a locality sensitivity of the complex control flow region; moving the region of the complex control flow region based on a latency sensitivity of the complex control flow region; or moving the region of the complex control flow region based on an elementary functional unit (EFU) grouping of the complex control flow region.

Aspect 5 is the method of any of aspects 1 to 4, wherein transforming the complex control flow region based on the code motion comprises at least one of: moving a region of the complex control flow region into a generated if statement region; moving the region of the complex control flow region into an existing if statement region; or moving the region of the complex control flow region into an if statement region of a generated if statement.

Aspect 6 is the method of any of aspects 1 to 5, wherein transforming the complex control flow region based on the code motion comprises: iteratively (a) performing a plurality of code motions of the complex control flow region based on a plurality of determinations that the set of complex inefficient instruction blocks comprises non-isomorphic regions and is eligible for transformation and (b) transforming the complex control flow region comprising at least one code motion of the plurality of code motions.

Aspect 7 is the method of aspect 6, wherein simplifying the control flow of the transformed complex control flow region comprises: simplifying the control flow of the transformed complex control flow region based on a determination that the iterations exceed a threshold limit; or simplifying the control flow of the transformed complex control flow region based on a determination that the transformed complex control flow region reached a steady state.

Aspect 8 is the method of any of aspects 1 to 7, wherein simplifying the control flow of the transformed complex control flow region comprises: reducing a plurality of exit outputs of the control flow of the transformed complex control flow region to a single exit output.

Aspect 9 is the method of any of aspects 1 to 8, wherein fusing the first redundancy portion and the second redundancy portion of the control flow graph based on the simplified control flow comprises: fusing the first redundancy portion and the second redundancy portion of the control flow graph based on the simplified control flow in response to a determination that the first redundancy portion and the second redundancy portion reached a steady state.

Aspect 10 is a method of optimizing a control flow graph, comprising: obtaining the control flow graph, wherein the control flow graph comprises a set of instruction blocks; identifying a set of inefficient instruction blocks comprising a set of redundant instructions based on the obtained control flow graph; determining a set of complex inefficient instruction blocks comprising non-isomorphic regions that are eligible for a transformation based on the identified set of complex inefficient instruction blocks; performing code motion of a complex control flow region of the control flow graph based on the determined set of complex inefficient instruction blocks; simplifying a control flow of the complex control flow region based on the performed code motion; and fusing a first redundancy portion and a second redundancy portion of the set of redundant instructions based on the simplified control flow.

Aspect 11 is the method of aspect 10, further comprising: compiling a representation of source code based on the control flow graph comprising the fused first redundancy portion and the second redundancy portion; and outputting the compiled representation of source code.

Aspect 12 is the method of either of aspects 10 or 11, wherein performing code motion of the complex control flow region of the control flow graph based on the determined set of complex inefficient instruction blocks comprises at least one of: hoisting code outside the complex control flow region; sinking code into the complex control flow region; or factoring code in the complex control flow region.

Aspect 13 is the method of any of aspects 10 to 12, wherein performing code motion of the complex control flow region of the control flow graph based on the determined set of complex inefficient instruction blocks comprises at least one of: moving a region of the complex control flow region based on divergent branches of the complex control flow region; moving the region of the complex control flow region based on early termination constructs of the complex control flow region; moving the region of the complex control flow region based on a register footprint of the complex control flow region; moving the region of the complex control flow region based on an instruction count of the complex control flow region; moving the region of the complex control flow region based on a locality sensitivity of the complex control flow region; moving the region of the complex control flow region based on a latency sensitivity of the complex control flow region; or moving the region of the complex control flow region based on an elementary functional unit (EFU) grouping of the complex control flow region.

Aspect 14 is the method of any of aspects 10 to 13, wherein simplifying the control flow of the transformed complex control flow region comprises: reducing a plurality of exit outputs of the control flow of the transformed complex control flow region to a single exit output.

Aspect 15 is the method of any of aspects 10 to 14, wherein fusing the first redundancy portion and the second redundancy portion of the set of redundant instructions based on the simplified control flow comprises: fusing the first redundancy portion and the second redundancy portion of the set of redundant instructions based on the simplified control flow based on a determination that the first redundancy portion and the second redundancy portion reached a steady state.

Aspect 16 is the method of any of aspects 10 to 15, further comprising: transforming the complex control flow region based on the performed code motion before simplifying the control flow of the complex control flow region.

Aspect 17 is the method of aspect 16, wherein transforming the complex control flow region based on the performed code motion comprises at least one of: moving a region of the complex control flow region into a generated if statement region; moving the region of the complex control flow region into an existing if statement region; or moving the region of the complex control flow region into an if statement region of a generated if statement.

Aspect 18 is the method of aspect 16, wherein transforming the complex control flow region based on the performed code motion comprises: iteratively (a) performing a plurality of code motions of the complex control flow region based on a plurality of determinations that the set of complex inefficient instruction blocks comprises non-isomorphic regions and is eligible for transformation and (b) transforming the complex control flow region comprising at least one code motion of the plurality of code motions.

Aspect 19 is the method of aspect 18, wherein simplifying the control flow of the complex control flow region comprises: simplifying the control flow of the transformed complex control flow region based on a determination that the iterations exceed a threshold limit; or simplifying the control flow of the transformed complex control flow region based on a determination that the transformed complex control flow region reached a steady state.

Aspect 20 is an apparatus for optimizing a control graph including at least one processor coupled to a memory and configured to implement a method as in any of aspects 1-19.

Aspect 21 may be combined with aspect 20 and includes that the apparatus is a wireless communication device.

Aspect 22 is an apparatus for optimizing a control graph including means for implementing a method as in any of aspects 1-19.

Aspect 23 is a computer-readable medium (e.g., a non-transitory computer-readable medium) storing computer executable code, the code when executed by at least one processor causes the at least one processor to implement a method as in any of aspects 1-19.

Various aspects have been described herein. These and other aspects are within the scope of the following claims.

What is claimed is:

1. An apparatus for optimizing a control flow graph, comprising:
a memory; and
a processor coupled to the memory and, based at least in part on information stored in the memory, the processor is configured to:
obtain the control flow graph, wherein the control flow graph comprises a set of instruction blocks;
identify a set of inefficient instruction blocks comprising a set of redundant instructions based on the obtained control flow graph;
determine a set of complex inefficient instruction blocks comprising non-isomorphic regions that are eligible for a transformation based on the identified set of complex inefficient instruction blocks;
perform code motion of a complex control flow region of the control flow graph based on the determined set of complex inefficient instruction blocks;
simplify a control flow of the complex control flow region based on the performed code motion; and
fuse a first redundancy portion and a second redundancy portion of the set of redundant instructions based on the simplified control flow.

2. The apparatus of claim 1, wherein the processor is further configured to:
compile a representation of source code based on the control flow graph comprising the fused first redundancy portion and the second redundancy portion; and
execute the compiled representation of the source code.

3. The apparatus of claim 1, wherein, to perform the code motion of the complex control flow region of the control flow graph based on the determined set of complex inefficient instruction blocks, the processor is configured to:
hoist code outside the complex control flow region;
sink code into the complex control flow region; or
factor code in the complex control flow region.

4. The apparatus of claim 1, wherein, to perform the code motion of the complex control flow region of the control flow graph based on the determined set of complex inefficient instruction blocks, the processor is configured to:
move a region of the complex control flow region based on divergent branches of the complex control flow region;
move the region of the complex control flow region based on early termination constructs of the complex control flow region;
move the region of the complex control flow region based on a register footprint of the complex control flow region;
move the region of the complex control flow region based on an instruction count of the complex control flow region;
move the region of the complex control flow region based on a locality sensitivity of the complex control flow region;
move the region of the complex control flow region based on a latency sensitivity of the complex control flow region; or
move the region of the complex control flow region based on an elementary functional unit (EFU) grouping of the complex control flow region.

5. The apparatus of claim 1, wherein, to simplify the control flow of the complex control flow region based on the performed code motion, the processor is configured to:
reduce a plurality of exit outputs of the control flow of the complex control flow region to a single exit output.

6. The apparatus of claim 1, wherein, to fuse the first redundancy portion and the second redundancy portion of the set of redundant instructions based on the simplified control flow, the processor is configured to:
fuse the first redundancy portion and the second redundancy portion of the set of redundant instructions based on the simplified control flow in response to a determination that the first redundancy portion and the second redundancy portion reached a steady state.

7. The apparatus of claim 1, wherein the processor is further configured to:
transform the complex control flow region based on the performed code motion before simplifying the control flow of the complex control flow region.

8. The apparatus of claim 7, wherein, to transform the complex control flow region based on the performed code motion, the processor is configured to:
move a region of the complex control flow region into a generated if statement region;
move the region of the complex control flow region into an existing if statement region; or
move the region of the complex control flow region into an if statement region of a generated if statement.

9. The apparatus of claim 7, wherein, to transform the complex control flow region based on the performed code motion, the processor is configured to:
iteratively (a) perform a plurality of code motions of the complex control flow region based on a plurality of determinations that the set of complex inefficient instruction blocks comprises the non-isomorphic regions and is eligible for the transformation and (b) transform the complex control flow region comprising at least one code motion of the plurality of code motions.

10. The apparatus of claim 9, wherein, to simplify the control flow of the complex control flow region, the processor is configured to:
simplify the control flow of the transformed complex control flow region based on a determination that the iterations exceed a threshold limit; or
simplify the control flow of the transformed complex control flow region based on a determination that the transformed complex control flow region reached a steady state.

11. The apparatus of claim 1, wherein the apparatus comprises a wireless communication device.

12. A method of optimizing a control flow graph, comprising:
obtaining the control flow graph, wherein the control flow graph comprises a set of instruction blocks;
identifying a set of inefficient instruction blocks comprising a set of redundant instructions based on the obtained control flow graph;
determining a set of complex inefficient instruction blocks comprising non-isomorphic regions that are eligible for a transformation based on the identified set of complex inefficient instruction blocks;
performing code motion on a complex control flow region of the control flow graph based on the determined set of complex inefficient instruction blocks;
simplifying a control flow of the complex control flow region based on the performed code motion; and
fusing a first redundancy portion and a second redundancy portion of the set of redundant instructions based on the simplified control flow.

13. The method of claim 12, further comprising:
compiling a representation of source code based on the control flow graph comprising the fused first redundancy portion and the second redundancy portion; and
outputting the compiled representation of the source code.

14. The method of claim 12, performing the code motion of the complex control flow region of the control flow graph based on the determined set of complex inefficient instruction blocks comprises at least one of:
hoisting code outside the complex control flow region;
sinking code into the complex control flow region; or
factoring code in the complex control flow region.

15. The method of claim 12, wherein performing the code motion of the complex control flow region of the control flow graph based on the determined set of complex inefficient instruction blocks comprises at least one of:
moving a region of the complex control flow region based on divergent branches of the complex control flow region;
moving the region of the complex control flow region based on early termination constructs of the complex control flow region;
moving the region of the complex control flow region based on a register footprint of the complex control flow region;
moving the region of the complex control flow region based on an instruction count of the complex control flow region;
moving the region of the complex control flow region based on a locality sensitivity of the complex control flow region;
moving the region of the complex control flow region based on a latency sensitivity of the complex control flow region; or
moving the region of the complex control flow region based on an elementary functional unit (EFU) grouping of the complex control flow region.

16. The method of claim 12, further comprising:
transforming the complex control flow region based on the performed code motion before simplifying the control flow of the complex control flow region.

17. The method of claim 16, wherein transforming the complex control flow region based on the performed code motion comprises at least one of:
moving a region of the complex control flow region into a generated if statement region;
moving the region of the complex control flow region into an existing if statement region; or
moving the region of the complex control flow region into an if statement region of a generated if statement.

18. The method of claim 16, wherein transforming the complex control flow region based on the performed code motion comprises:
iteratively (a) performing a plurality of code motions of the complex control flow region based on a plurality of determinations that the set of complex inefficient instruction blocks comprises the non-isomorphic regions and is eligible for the transformation and (b) transforming the complex control flow region comprising at least one code motion of the plurality of code motions, wherein simplifying the control flow of the complex control flow region based on the performed code motion comprises:
simplifying the control flow of the transformed complex control flow region based on a determination that the iterations exceed a threshold limit; or
simplifying the control flow of the transformed complex control flow region based on a determination that the transformed complex control flow region reached a steady state.

19. The method of claim 12, wherein fusing the first redundancy portion and the second redundancy portion of the set of redundant instructions based on the simplified control flow comprises:
fusing the first redundancy portion and the second redundancy portion of the set of redundant instructions based on the simplified control flow in response to a determination that the first redundancy portion and the second redundancy portion reached a steady state.

20. A computer-readable medium storing computer executable code, the code when executed by a processor, causes the processor to:
obtain a control flow graph, wherein the control flow graph comprises a set of instruction blocks;
identify a set of inefficient instruction blocks comprising a set of redundant instructions based on the obtained control flow graph;
determine a set of complex inefficient instruction blocks comprising non-isomorphic regions that are eligible for a transformation based on the identified set of complex inefficient instruction blocks;
perform code motion on a complex control flow region of the control flow graph based on the determined set of complex inefficient instruction blocks;
simplify a control flow of the complex control flow region based on the performed code motion; and
fuse a first redundancy portion and a second redundancy portion of the set of redundant instructions based on the simplified control flow.
